(19) United States
(12) Patent Application Publication
(10) Pub. No.: US 2016/0236975 A1
(43) Pub. Date: Aug. 18, 2016

(54) COVER GLASS FOR PEN INPUT DEVICE AND METHOD FOR MANUFACTURING SAME

(71) Applicant: Asahi Glass Company, Limited, Chiyoda-ku (JP)

(72) Inventors: Naoki SUGIMOTO, Chiyoda-ku (JP); Takashi SHIBUYA, Chiyoda-ku (JP); Keisuke HANASHIMA, Chiyoda-ku (JP); Osamu HOMMA, Chiyoda-ku (JP); Katsumi SUZUKI, Chiyoda-ku (JP); Kiyohisa NAKAMURA, Chiyoda-ku (JP); Nobuhiko TAKESHITA, Chiyoda-ku (JP)

(73) Assignee: Asahi Glass Company, Limited, Chiyoda-ku (JP)

(21) Appl. No.: 15/137,150

(22) Filed: Apr. 25, 2016

Related U.S. Application Data
(63) Continuation of application No. PCT/JP2014/078038, filed on Oct. 22, 2014.

(30) Foreign Application Priority Data
Nov. 14, 2013 (JP) 2013-235870
Apr. 16, 2014 (JP) 2014-084254

(51) Int. Cl. C03C 15/00; C03C 3/091; C03C 3/083; G06F 3/041; C03C 3/087; C03C 21/00; C03C 17/30; C03C 3/093; C03C 3/085

(52) U.S. Cl. CPC C03C 15/00; C03C 3/093; C03C 3/091; C03C 3/083; C03C 3/085; C03C 3/087; C03C 21/002; C03C 17/30; G06F 3/041; C03C 2218/15

(57) ABSTRACT

A cover glass for a pen input device has a haze value of less than 1%, and a Martens hardness within a range from 2000 N/mm² to 4000 N/mm². When a moving member receiving a load of 150 gf (1.47 N) is moved in one direction, at 10 mm/sec, at room temperature, on the surface of the cover glass, a coefficient of kinetic friction μₖ of a kinetic frictional force Fₖ (N) exerted by the cover glass surface within a region where an approximately linear relationship is established between the kinetic frictional force Fₖ (N) and the time is 0.14˜0.50, and a standard deviation σ (N) of the kinetic frictional force Fₖ (N) is no more than 0.03. The moving member is a pen that includes a pen tip made of polyacetal resin with a Rockwell hardness of M90 and having a radius of curvature of 700 μm.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2014/078038 filed on Oct. 22, 2014 and designating the U.S., which claims priority to Japanese Patent Application No. 2013-235870 filed on Nov. 14, 2013 and Japanese Patent Application No. 2014-084254 filed on Apr. 16, 2014. The entire contents of the foregoing applications are incorporated herein by reference.

### BACKGROUND OF THE INVENTION

1. Field of the Invention

The present invention relates to a cover glass for a pen input device and a method for manufacturing the same.

2. Description of the Related Art

Pen input devices enable an input operation with an input pen similar to the experience of writing characters or drawing figures on paper. Such pen input devices are widely used in various devices, such as a tablet-type portable information terminal, an electronic notebook, an image drawing pen tablet, a tablet-type personal computer, and the like.

Such pen input devices include a cover member made of glass or resin, for example, arranged on the front surface of a display device, such as a liquid crystal display, for example. By placing the input pen in contact with such a cover member and moving the input pen, various input operations may be intuitively performed.

Japanese Laid-Open Patent Publication No. 2009-151476 describes using a resin sheet having an anti-glare layer arranged on its surface as a cover member of a pen input device. By using such a cover member, a “writing feeling” experienced upon performing a pen input operation with an input pen may be improved, and fingerprints adhered to the surface of the cover glass may be less visible.

As mentioned above, the cover member described in Japanese Laid-Open Patent Publication No. 2009-151476 has an anti-glare layer arranged on the surface of the resin sheet in order to improve the “writing feeling” of the input pen.

However, owing to the anti-glare properties of such anti-glare layer, the transparency of the cover member may be decreased. For example, the haze value of the cover member according to Japanese Laid-Open Patent Publication No. 2009-151476 is at least 6%, indicating that the transparency of the cover member is relatively low.

Recently, display devices with increasingly higher definition are being developed, and a demand for pen input devices that can accommodate such increase in definition is also anticipated. However, a pen input device with a cover member including an anti-glare layer may not be able to meet such a demand.

### SUMMARY OF THE INVENTION

According to an aspect of the present invention, a cover glass for a high-definition pen input device that can provide an enhanced “writing feeling” is provided. According to another aspect of the present invention, a method for manufacturing such a cover glass for a pen input device is provided.

According to one embodiment of the present invention, a cover glass for a pen input device is provided that has a haze value of less than 1%, and a Martens hardness within a range from 2000 N/mm² to 4000 N/mm². When a moving member receiving a load of 150 gf (1.47 N) is moved in one direction, at a velocity of 10 mm/sec, at room temperature, on a surface of the cover glass, a coefficient of kinetic friction μₖ of a kinetic frictional force Fₖ (N) between the moving member and the surface of the cover glass within a region where a relationship between the kinetic frictional force Fₖ (N) and time is approximated by a straight line is greater than or equal to 0.14 and less than or equal to 0.50, and a standard deviation σ (N) of the kinetic frictional force Fₖ (N) is less than or equal to 0.03. The moving member is a pen that includes a pen tip made of polyacetal resin having a Rockwell hardness of M90, and the pen tip has a radius of curvature of 700 μm.

According to another embodiment of the present invention, a cover glass for a pen input device is provided that has a haze value of less than 1%, and a Martens hardness within a range from 2000 N/mm² to 4000 N/mm². When a moving member is moved in one direction on a surface of the cover glass, assuming Fₖ (N) represents a kinetic frictional force between the moving member and the surface of the cover glass, σ (N) represents a standard deviation of the kinetic frictional force Fₖ (N), and Y represents σ/Fₖ, Y is less than or equal to 0.05.

According to another embodiment of the present invention, a cover glass for an input device used by a user to input information is provided that has a haze value of less than 1%, and a Martens hardness within a range from 2000 N/mm² to 4000 N/mm². When a synthetic leather receiving a load of 50 gf (0.49 N) is moved in one direction, at a velocity of 1 mm/sec, at room temperature, on a surface of the cover glass, assuming Fₖ (N) represents a kinetic frictional force between the synthetic leather and the surface of the cover glass, σ (N) represents a standard deviation of the kinetic frictional force Fₖ (N), and Y represents σ/Fₖ, a coefficient of kinetic friction μₖ within a region where a relationship between the kinetic frictional force Fₖ (N) and time is approximated by a straight line is greater than or equal to 0.9, and Y is less than or equal to 0.05.

According to another embodiment of the present invention, a method for manufacturing a cover glass for a pen input device is provided that includes applying a processing gas containing hydrogen fluoride (HF) gas on a surface of a glass substrate. After processing the glass substrate with the processing gas, the glass substrate is arranged to have a haze value of less than 1%, and a Martens hardness within a range from 2000 N/mm² to 4000 N/mm². When a moving member is moved in one direction on the surface of the glass substrate, assuming Fₖ (N) represents a kinetic frictional force between the moving member and the surface of the glass substrate, σ (N) represents a standard deviation of the kinetic frictional force Fₖ (N), and Y represents σ/Fₖ, Y is arranged to be less than or equal to 0.05.

According to another embodiment of the present invention, a method for manufacturing a cover glass for a pen input device is provided that includes applying a processing gas containing hydrogen fluoride (HF) gas on a surface of a glass substrate. After processing the glass substrate with the processing gas, the glass substrate is arranged to have a haze value of less than 1%, and a Martens hardness within a range from 2000 N/mm² to 4000 N/mm². When a pen including a pen tip, which is made of polyacetal resin with a Rockwell hardness of M90 and has a radius of curvature of 700 μm, is placed on the surface of the glass substrate at a load of 150 gf (1.47 N) and is moved in one direction, at a velocity of 10 mm/sec, at room temperature, a coefficient of kinetic friction μₖ of a kinetic frictional force Fₖ (N) between the moving member and the surface of the glass substrate within a region where a relationship between the kinetic frictional force Fₖ (N) and time is approximated by a straight line is greater than or equal to 0.14 and less than or equal to 0.50, and a standard deviation σ (N) of the kinetic frictional force Fₖ (N) is less than or equal to 0.03.

### BRIEF DESCRIPTION OF THE DRAWINGS

FIG. 1 is a graph schematically showing the relationship between the time t and the frictional force F (kinetic frictional force) when an object receiving a constant load P moves at a constant velocity on a surface;

FIG. 2 is a graph schematically showing the relationship between the time t and the kinetic frictional force Fₖ (N) the surface is in a first state;

FIG. 3 is a graph schematically showing the relationship between the time t and the kinetic frictional force Fₖ (N) when the surface is in a 15 second state;

FIG. 4 is a graph schematically showing the relationship between the time t and the kinetic frictional force Fₖ (N) when the surface is in a third state;

FIG. 5 is a schematic cross-sectional view of a pen input device including a cover glass according to an embodiment of the present invention;

FIG. 6 is a flow chart schematically showing a method for manufacturing a cover glass according to an embodiment of the present invention;

FIG. 7 is a diagram showing an example configuration of a processing apparatus that performs an etching process on a glass substrate while the glass substrate is being conveyed;

FIG. 8 is a cross-sectional photographic image of a cover glass according to Example 1-1;

FIG. 9 is a photographic image of the surface of the cover glass according to Example 1-1;

FIG. 10 is a cross-sectional photographic image of a cover glass according to Example 3-1;

FIG. 11 is a photographic image of the surface of the cover glass according to Example 3-1;

FIG. 12 is a photographic image of the surface of a cover glass according to Example 1-2;

FIG. 13 is a photographic image of the surface of a cover glass according to Example 3-2; and

FIG. 14 is a graph comparing the coefficients of kinetic friction of the cover glasses according to Examples 1-3 and 3-3, and the coefficient of kinetic friction of a glass substrate that has only undergone a chemical strengthening process and an anti-fingerprint coating process.

### DESCRIPTION OF THE PREFERRED EMBODIMENTS

In the following, embodiments of the present invention will be described with reference to the accompanying drawings.

(First Cover Glass)

In the following, a cover glass according to one embodiment of the present invention (also referred to as “first cover glass”) is described.

As described above, the cover member according to Japanese Laid-Open Patent Publication No. 2009-151476 has an anti-glare layer arranged on the surface of a resin sheet in order to improve the “writing feeling” of the input pen.

However, owing to the anti-glare properties of such anti-glare layer, the transparency of the cover member may be decreased. For example, the haze value of the cover member of Japanese Laid-Open Patent Publication No. 2009-151476 is at least 6%. With such a cover member having a relatively high haze value, input devices may not be able to meet the demand for higher definition capabilities.

In this respect, according to one embodiment of the present invention, a cover glass for a pen input device is provided that has a haze value of less than 1%, and a Martens hardness within a range from 2000 N/mm² to 4000 N/mm². When a moving member (synthetic leather) is moved in one direction on a surface of the cover glass, assuming Fₖ (N) represents a kinetic frictional force between the moving member and the surface of the cover glass, σ (N) represents a standard deviation of the kinetic frictional force Fₖ (N), and Y represents σ/Fₖ, Y is less than or equal to 0.05.

Also, in one preferred embodiment, when a synthetic leather receiving a load of 50 gf (0.49 N) is moved in one direction, at a velocity of 1 mm/sec, at room temperature, on the surface of the cover glass, the coefficient of kinetic friction μₖ within a region where the relationship between the kinetic frictional force Fₖ (N) and the time is approximated by a straight line may be greater than or equal to 0.9.

Note that the haze value is an index representing the opacity of the cover glass. That is, the lower the haze value, the higher the transparency of the cover glass. In the present description, the haze value is measured according to JIS K7361-1.

The cover glass according to the present embodiment does not include an anti-glare structure, and therefore has a haze value of less than 1%. That is, the cover glass according to the present embodiment has relatively high transparency.

Thus, the cover glass according to the present embodiment may be able to adequately meet the demand for enhanced definition capabilities in pen input devices arising from the development of higher definition display devices.

Also, note that the Martens hardness is an index representing the softness of the surface of the cover glass. In the present description, the Martens hardness is measured according to ISO 14577.

The Martens hardness of the surface of the cover glass is associated with “indentation” of the cover glass upon being operated with the input pen. That is, when the Martens hardness of the cover glass is too low, abrasion resistance is decreased. On the other hand, when the Martens hardness is too high, “indentation” of the cover glass is decreased, and as a result, the cover glass may feel too rigid such that discomfort may be felt upon operating the input pen, or input operations may induce more fatigue, for example.

The cover glass according to the present embodiment has a Martens hardness within the range from 2000 N/mm² to 4000 N/mm². In this case, adequate “indentation” may be felt upon operating the input pen and the “writing feeling” may be improved. Also, the cover glass according to the present embodiment has a Martens hardness of at least 2000 N/mm², and as such, durability of the cover glass may be improved.

According to an aspect of the present embodiment, the Martens hardness of the cover glass is preferably within the range from 2000 N/mm² to 4000 N/mm², and more preferably within the range from 2000 N/mm² to 3500 N/mm².

According to another aspect of the present embodiment, when a synthetic leather receiving a load of 50 gf (0.49 N) is moved in one direction, at a velocity of 1 mm/sec, at room temperature, on the surface of the cover glass, the coefficient of kinetic friction μₖ within a region where an approximately linear relationship is established between the kinetic frictional force Fₖ (N) and the time t is greater than or equal to 0.9, and assuming σ (N) represents the standard deviation of the kinetic frictional force Fₖ (N) within such a region and Y represents σ/Fₖ, the value of Y is less than or equal to 0.05.

The value of Y is preferably less than or equal to 0.05, and more preferably less than or equal to 0.04. The coefficient of kinetic friction μₖ is preferably within the range from 0.9 to 4.0, and more preferably within the range from 0.9 to 3.5. When the value of Y is greater than 0.5, the resistance applied to the input pen may become irregular, and as a result, a jerky (chattering) sensation may be felt upon operating the input pen such that the writing feeling may be degraded. On the other hand, the writing feeling may be improved when the value of Y is less than or equal to 0.04. Also, note that the value of Y is not limited by a particular minimum value, and the smaller the value of Y, the lower the jerky sensation and the smoother the writing feeling.

Also, when the value of Y is less than or equal to 0.05, noise (sound) generated upon operating the input pen may be substantially suppressed such that discomfort experienced by the user from such noise may be eliminated or reduced.

When the coefficient of kinetic friction μₖ is less than 0.9, the writing feeling may be too light, and when the coefficient of kinetic friction μₖ is greater than 4.0, the writing feeling may be too heavy. Note that the coefficient of kinetic friction μₖ may be adjusted as appropriate depending on the application, but in the present embodiment, the coefficient of kinetic friction μₖ is preferably within the above range.

By arranging the cover glass according to the present embodiment to have the features as described above, the writing feeling may be substantially improved.

In the following, such an effect is described in detail with reference to the drawings.

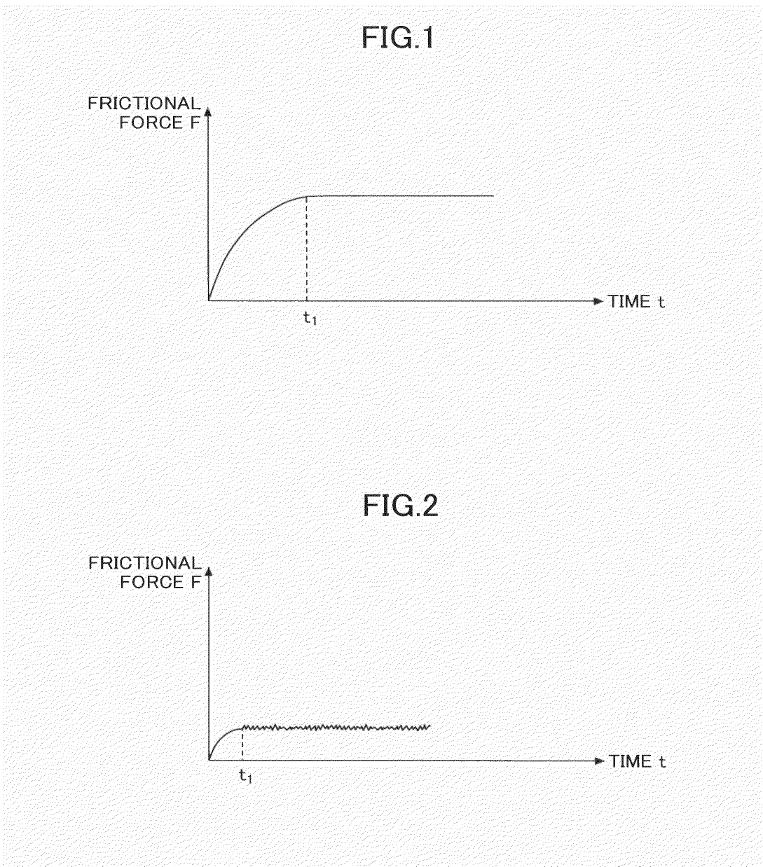

FIG. 1 is a graph schematically showing the relationship between the time t (or moving distance) and the frictional force F when an object receiving a constant load P moves at a constant velocity on a surface.

As shown in FIG. 1, generally after an object starts to move at a steady velocity (after time t=t₁), a linear relationship is established between the frictional force F (kinetic frictional force Fₖ) and the time t. Note that in this time region, the kinetic frictional force Fₖ tends to be relatively constant irrespective of the time t. Also, in general, the following relationship as represented by Formula (1) is established between the kinetic friction force Fₖ (N) and the load P (N):

Fₖ=μₖ×P Formula (1)

In the above Formula (1), μₖ represents the coefficient of kinetic friction, which may vary depending on the state of the surface and the like.

FIGS. 2-4 are graphs schematically showing varying relationships between the kinetic friction force Fₖ and the time t depending on the state of the surface.

FIG. 2 shows the relationship obtained when the moving surface is very smooth. With such a surface, the coefficient of kinetic friction μₖ tends to be small such that the value of Y tends to increase, and as a result, a jerky sensation may be conspicuously felt. Further, because the coefficient of kinetic friction μₖ tends to be small, the kinetic frictional force Fₖ may also be small.

When an input pen is used on a cover glass having such a surface, the input pen may slide too easily, and it may be difficult to perform a desired input operation.

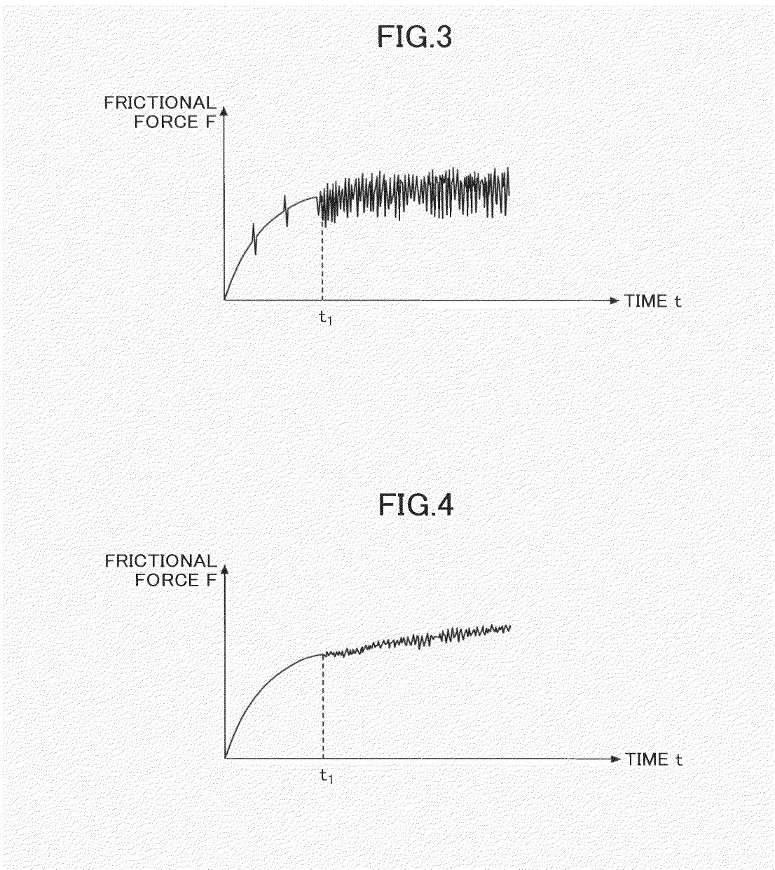

FIG. 3 shows the relationship obtained when the moving surface is highly uneven (rough). With such a moving surface, wide variations may occur in the coefficient of kinetic friction μₖ while the object is moving, and as such, there may be wide variations in the kinetic frictional force Fₖ as well. As a result, the value of Y may increase, and the jerky sensation may be conspicuously felt.

When an input pen is used on a cover glass having such a surface, the jerky sensation of the input pen may be felt such that the writing feeling may be degraded and the user may feel stressed.

In contrast, when the state of the moving surface is in between the above two states, a relationship between the kinetic frictional force Fₖ and the time t as shown in FIG. 4 may be obtained.

With such a surface, the value of Y may decrease, the kinetic frictional force Fₖ and the coefficient of kinetic friction μₖ may be adequately large, and variations in the kinetic frictional force Fₖ and the coefficient of kinetic friction μₖ may be reduced.

When an input pen is used on a cover glass having such a surface, an adequate resistive force may be applied to the input pen that is moved with respect to the cover glass. As such, unintended sliding of the input pen may be suppressed. Also, variations in the coefficient of kinetic friction μₖ may be reduced, and the jerky sensation felt while moving the input pen may be less conspicuous. Thus, with such a surface, the writing feeling may be improved upon placing the input pen in contact with the cover glass and moving the input pen.

Note that according to an aspect of the present embodiment, assuming σ (N) represents the standard deviation of the kinetic frictional force Fₖ (N) in the region where the relationship between the kinetic frictional force Fₖ (N) and the time is approximated by a straight line (e.g., see time region after t₁ in FIGS. 1-4), the value of Y (Y=σ/Fₖ) is less than or equal to 0.5.

In this case, the jerky sensation of the input pen that tends to be generated by a surface that establishes a relationship between the kinetic frictional force Fₖ (N) and the time t as shown in FIG. 3 may be suppressed. Thus, discomfort may be reduced in operating the input pen, and the input pen may be moved as desired.

Thus, according to an aspect of the present embodiment, the surface of a cover glass is adjusted to establish a relationship between the kinetic frictional force Fₖ (N) and the time t as shown in FIG. 4, and in this way, the writing feeling of the cover glass may be improved.

Note that in some embodiments, at least a portion of the cover glass is arranged to achieve the desired writing feeling as described above. Also, the surface of the cover glass may be composed of a plurality of regions having different values for Y (σ/Fₖ). In this way, predetermined positions on the cover glass may be distinguished by recognizing the differences in the writing feeling at these positions.

According to an aspect of the present embodiment, when a synthetic leather receiving a load of 50 gf (0.49 N) is moved in one direction, at a velocity of 1 mm/sec, at room temperature, on the surface of the cover glass, the coefficient of kinetic friction μₖ in a region where the relationship between the kinetic friction force Fₖ (N) and the time is approximated by a straight line (see e.g., time region after t₁ in FIGS. 1-4) is greater than or equal to 0.9.

In this case, when moving the input pen with respect to the cover glass, an adequate resistive force may be applied to the input pen. Thus, unintended sliding of the input pen that tends to occur on a surface that establishes a relationship between the kinetic frictional force Fₖ (N) and the time as shown in FIG. 2 may be suppressed.

According to another aspect of the present embodiment, the surface roughness Ra (arithmetic average roughness) of the cover glass is preferably within the range from 0.2 nm to 20 nm, and the surface roughness Rz (maximum height roughness) is preferably within the range from 3.5 nm to 200 nm. For example, the surface roughness Ra may be within the range from 1 nm to 15 nm, and the surface roughness Rz may be within the range from 20 nm to 150 nm.

Note that in the present description, the surface roughness Rz refers to a value obtained according to JIS B0601 (2001).

Also, the contact angle of the surface of the cover glass with respect to a water droplet is preferably greater than or equal to 100 degrees. In this case, fingerprint adhesiveness of the cover glass may be substantially reduced. In some preferred embodiments, the contact angle of the surface of the cover glass with respect to a water droplet may be greater than or equal to 110 degrees, for example. Note that the surface of the cover glass may be coated with an anti-fingerprint (AFP) material to achieve such characteristics, for example. Also, in some embodiments, such a coating process may be performed on at least a portion of the surface of the cover glass, for example. In this way, predetermined positions on the cover glass may be distinguished by recognizing the differences in the writing feeling at these positions, for example.

(Second Cover Glass)

In the following, a cover glass according to another embodiment of the present invention (also referred to as “second cover glass”) is described.

The second cover glass according to the present embodiment has a haze value of is less than 1%, and a Martens hardness within the range from 2000 N/mm² to 4000 N/mm².

When a moving member receiving a load of 150 gf (1.47 N) is moved in one direction, at a velocity of 10 mm/sec, at room temperature, the coefficient of kinetic friction μₖ in a region where the relationship between the kinetic frictional force Fₖ (N) and the time is approximated by a straight line is greater than or equal to 0.14 and less than or equal to 0.50, and the standard deviation σ (N) of the kinetic frictional force Fₖ (N) is less than or equal to 0.03.

The moving member is a pen that includes a pen tip made of polyacetal resin having a Rockwell hardness of M90, and the pen tip has a radius of curvature of 700 μm.

As described in detail below, the second cover glass having the above features can achieve advantageous effects similar to those of the first cover glass.

Specifically, the second cover glass has adequately high transparency to meet the demand for pen input devices with enhanced definition capabilities.

Also, the second cover glass can provide an adequate sensation of “indentation” and adequate durability.

Further, the second cover glass can provide a desirably effective writing feeling.

Note that an area of the cover glass achieving the desired writing feeling does not have to be the entire surface of the cover glass but may be at least a portion of the cover glass, for example. Also, the surface of the cover glass may be composed of a plurality of regions, and the coefficients of kinetic friction μₖ and the standard deviations σ of the kinetic frictional force Fₖ exerted by these regions may be arranged to differ from one another, for example. In this way, predetermined positions on the cover glass may be distinguished by recognizing the differences in the writing feeling at these positions.

(Other Features)

(Composition of Cover Glass)

The glass composition of a cover glass according to an embodiment of the present invention is not particularly limited. For example, the cover glass may be made of soda-lime silicate glass, aluminosilicate glass, alkali-free glass, or the like.

The glass composition of the cover glass may include SiO₂ at 61-77 mol %, Al₂O₃ at 1-18 mol %, Na₂O at 8-18 mol %, K₂O at 0-6 mol %, MgO at 0-15 mol %, B₂O₃ at 0-8 mol %, CaO at 0-9 mol %, SrO at 0-1 mol %, BaO at 0-1 mol %, and ZrO₂ at 0-4 mol %.

Note that SiO₂ is an essential component providing structure for the glass. When the mole percent of SiO₂ is less than 61 mol %, the glass may be susceptible to cracking when the glass surface is scratched, weather resistance of the glass may be degraded, the specific gravity of the glass may increase, or the liquid phase temperature of the glass may increase such that the glass becomes unstable. In this respect, the mole percent of SiO₂ is preferably greater than or equal to 63 mol %. On the other hand, when the mole percent of SiO₂ exceeds 77 mol %, a temperature T2 at which the glass has a viscosity of 10² dPa·s or a temperature T4 at which the glass has a viscosity of 10⁴ dPa·s may increase such that it may be difficult to dissolve or mold the glass. Also, weather resistance of the glass may be degraded. In this respect, the mole percent of SiO₂ is preferably less than or equal to 70 mol %.

Al₂O₃ is an essential component for improving ion exchange performance and weather resistance of the glass. When the mole percent of Al₂O₃ is less than 1 mol %, a desired surface compressive stress and/or a desired compressive stress layer thickness may not be obtained through ion exchange, or the weather resistance of the glass may be easily degraded. In this respect, the mole percent of Al₂O₃ is preferably greater than or equal to 5 mol %. On the other hand, when the mole percent of Al₂O₃ exceeds 18 mol %, the temperature T2 or T4 may increase to thereby make it difficult to dissolve or mold the glass, or the liquid phase temperature of the glass may increase such that the glass may be susceptible to devitrification.

Na₂O is an essential component of the glass for reducing variations in the surface compressive stress during ion exchange, forming a surface compressive stress layer through ion exchange, and/or improving the meltability of the glass. When the mole percent of Na₂O is less than 8 mol %, it may be difficult to form a desired surface compressive stress layer through ion exchange, or the temperature T2 or T4 may increase to thereby make is difficult to dissolve or mold the glass. In this respect, the mole percent of Na₂O is preferably greater than or equal to 10 mol %. On the other hand, when the mole percent of Na₂O exceeds 18 mol %, the weather resistance of the glass may be degraded, or the glass may be susceptible to cracking upon indentation.

K₂O is not an essential component of the glass but contributes to increasing the ion exchange rate. The glass may contain up to 6 mol % of K₂O. When the mole percent of K₂O exceeds 6 mol %, variations in the surface compressive stress developed during ion exchange may increase, the glass may be susceptible to cracking upon indentation, or the weather resistance of the glass may be degraded.

MgO may be contained in the glass to improve the meltability of the glass. When the mole percent of Mgo exceeds 15 mol %, variations in the surface compressive stress developed during ion exchange may increase, the liquid phase temperature of the glass may increase to thereby make the glass susceptible to devitrification, or the ion exchange rate may decrease. In this respect, the mole percent of MgO is preferably less than or equal to 12 mol %.

B₂O₃ is preferably contained in the glass at a mole percent of less than or equal to 8 mol % in order to improve the meltability of the glass. When the mole percent of B₂O₃ exceeds 8 mol %, it may be difficult to obtain a homogeneous glass, and molding the glass may be difficult.

CaO may be contained in the glass at a mole percent of less than or equal to 9 mol % in order to improve the meltability of the glass at a high temperature, or to prevent devitrification of the glass. However, note that CaO may potentially increase variations in the surface compressive stress developed during ion exchange, decrease the ion exchange rate, or decrease resistance to cracking.

SrO may be contained in the glass at a mole percent of less than or equal to 1 mol % in order to improve the meltability of the glass at a high temperature, or to prevent devitrification of the glass. However, note that SrO may increase variations in the surface compressive stress developed during ion exchange, decrease the ion exchange rate, or decrease resistance to cracking.

BaO may be contained in the glass at a mole percent of less than of equal to 1 mol % in order to improve the meltability of the glass at a high temperature, or to prevent devitrification of the glass. However, note that BaO may increase variations in the surface compressive stress developed during ion exchange, decrease the ion exchange rate, or decrease resistance to cracking.

ZrO₂ is not an essential component of the glass but may be contained in the glass at a mole percent of less than or equal to 4 mol % in order to increase the surface compression stress. When the mole percent of ZrO₂ exceeds 4 mol %, variations in the surface compressive stress developed during ion exchange may increase, or resistance to cracking may decrease.

(Dimensions)

The dimensions and shape of a cover glass according to an embodiment of the present invention are not particularly limited. For example, the cover glass may have a thickness of 0.3 mm to 2.0 mm. The shape of the cover glass may be substantially rectangular, substantially circular, substantially elliptical, or be in some other suitable shape. Also, the cover glass may be flat or slightly curved, for example.

(Chemical Strengthening Process)

In a preferred embodiment, a chemical strengthening process may be performed on the cover glass. In this way, durability of the cover glass may be enhanced.

(Pen Input Device)

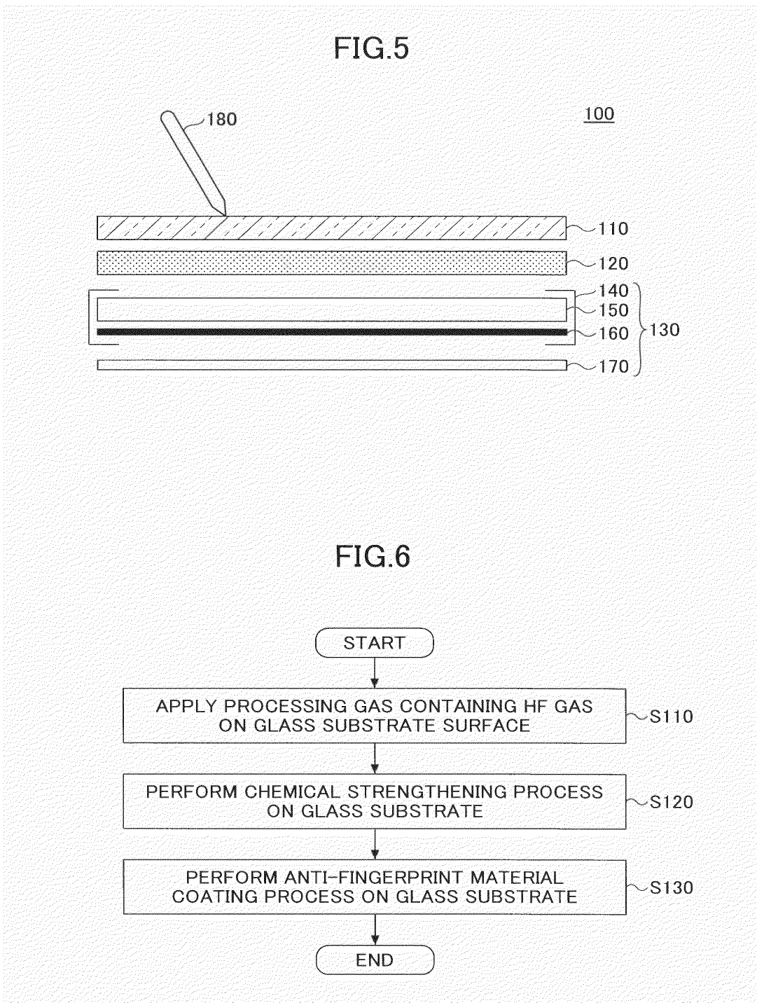

In the following, an example application of a cover glass according to an embodiment of the present invention is described with reference to FIG. 5.

Note that an application of the first cover glass is described below. However, it should be apparent to those skilled in the art that the descriptions below may similarly apply to the second cover glass.

FIG. 5 is a schematic cross-sectional view of a pen input that includes the first cover glass according to an embodiment of the present invention.

As shown in FIG. 5, the pen input device 100 includes a cover glass 110, a display device 120, and a digitizer circuit 130.

The cover glass 110 corresponds to the first cover glass according to an embodiment of the present invention having the features as described above. The cover glass 110 is arranged on a front surface of the display device 120.

The display device 120 is not limited to a particular type of display device as long as it is capable of displaying an image. For example, the display device 120 may be a liquid crystal display (LCD), a plasma display (PDP), an electroluminescent (EL) display, a cathode ray tube (CRT) display, or the like.

The digitizer circuit 130 is arranged on a rear surface of the display device 120. The digitizer circuit 130 includes an electrode 140, a spacer 150, a grid 160, and a detection circuit 170.

Note that an input pen 180 is used to perform an input operation on the pen input device 100.

The input pen 180 is arranged into a shape simulating a writing instrument such as a pencil or a ball-point pen. An input operation may be performed on the pen input device 100 by placing the input pen 180 in contact with the surface of the cover glass 110 and drawing objects on the surface of the cover glass 110 with the input pen 180. For example, a circuit may be included in the input pen 180, and in this way, an input system using electromagnetic induction may be configured by the input pen 180 and the pen input device 100.

As described above, the cover glass 110 has no anti-glare structure and therefore has high transparency. Thus, even when a high-definition display device is used as the display device 120, the high-definition capabilities of the display device 120 may not be compromised by the cover glass 110.

In this way, high-definition images and objects may be drawn and intricate input operations may be performed on the pen input device 100. For example, in a case where the pen input device 100 is a tablet-type image drawing device, more delicate and expressive images may be drawn.

Also, as described above, the Martens hardness of the cover glass 110 is arranged to be within the range from 2000 N/mm² to 4000 N/mm². Thus, adequate “indentation” may be felt when the input pen 180 is operated, thereby improving the writing feeling imparted by the input pen 180.

Also, the durability of the cover glass 110 may be enhanced, and as a result, the durability of the pen input device 100 may be enhanced.

Further, as described above, when a synthetic leather receiving a load of 50 gf (0.49 N) is moved in one direction, at a velocity of 1 mm/sec, at room temperature, on the surface of the cover glass 110, the coefficient of kinetic friction μₖ in a region where the relationship between the kinetic frictional force Fₖ (N) and the time is approximated by a straight line is at least 0.9, and assuming σ (N) represents the standard deviation of the kinetic frictional force Fₖ (N) within the above region and Y represents σ/Fₖ, the value of Y is less than or equal to 0.05.

Thus, when using the input pen 180 on the pen input device 100, the input pen 180 may be prevented from sliding too easily on the surface of the cover glass 110, or conversely, the sliding movement of the input pen 180 may be prevented from being overly restrained to compromise desired mobility of the input pen 180.

In this way, the operability of the input pen 180 with respect to the pen input device 100 may be improved, and a desirably effective writing feeling may be obtained.

Note that the pen input device 100 shown in FIG. 5 is merely one example, and a cover glass according to an embodiment of the present invention may be applied to an input device having various other structures. For example, a cover glass according to an embodiment of the present invention may be applied to a tablet-type portable information terminal, an electronic notebook, an image drawing pen tablet, a tablet-type personal computer, and other types of input devices.

(Method for Manufacturing Cover Glass)

In the following, a method for manufacturing a cover glass according to an embodiment of the present invention is described with reference to FIG. 6.

FIG. 6 is a flowchart schematically showing a method for manufacturing the first cover glass according to an embodiment of the present invention (also referred to as “first manufacturing method” hereinafter). As shown in FIG. 6, the first manufacturing method includes the following process steps.

(a) Apply a processing gas containing hydrogen fluoride (HF) gas on the surface of a glass substrate (step S110);

(b) Perform a chemical strengthening process on the glass substrate (step S120); and

(c) Perform an anti-fingerprint (AFP) coating process on the glass substrate (step S130).

Note, however, that steps S120 and S130 are process steps that are optionally performed. That is, in some embodiments, one or both of these process steps may be omitted.

In the following, the above process steps S110-S130 are described in detail.

(Step S110)

First, a glass substrate is prepared.

The type of the glass substrate is not particularly limited. For example, the glass substrate may be made of soda lime silicate glass, aluminosilicate glass, alkali-free glass, or the like. Note, however, that in the case of performing the chemical strengthening process of step S120, the glass substrate has to contain an alkali metal element.

Note that in a case where the glass substrate contains an alkali metal element, an alkaline earth metal element, and/or aluminum, a fluorine compound is more likely to remain in the vicinity of the glass substrate surface when processing the glass substrate surface with the processing gas containing hydrogen fluoride (HF) gas.

Such residual fluorine compound contributes to improving light transmittance of the glass substrate. That is, a refractive index (n₁) of the residual fluorine compound is normally between a refractive index (n₂) of the glass substrate and a refractive index (n₀) of air. Thus, by arranging the glass substrate, the fluorine compound, and air in the above recited order, light transmittance of the glass substrate may be improved.

The glass substrate preferably has a high light transmittance of at least 80% for a wavelength range from 350 nm to 800 nm, for example. Also, the glass substrate preferably has adequate insulation and adequate chemical and physical durability.

Note that the method for manufacturing the glass substrate is not particularly limited. For example, the glass substrate may be manufactured by a float process.

The thickness of the glass substrate is preferably less than or equal to 2 mm. For example, the thickness of the glass substrate may be within the range from 0.3 mm to 1.5 mm. The thickness of the glass substrate is more preferably within the range from 0.5 mm to 1.1 mm. If the thickness of the glass substrate is greater than 2 mm, weight reduction of the glass substrate may be hindered and the raw material cost may increase.

Next, the glass substrate that has been prepared is exposed to a processing gas containing hydrogen fluoride (HF) gas, and an etching process is performed on the glass substrate.

Note that in the present description, the term “etching process” simply refers to a process of applying a processing gas containing hydrogen fluoride gas on the surface of the glass substrate, irrespective of the actual etching amount. That is, even a process with a very small etching amount (e.g., process of forming asperities in the order of 1 nm to 200 nm) is regarded as an etching process.

The etching process may be performed on the surface of the glass substrate to form a processed layer having fine asperities in the order of 1 nm to 200 nm, for example. By forming such fine asperities, antireflection properties of the glass substrate may be enhanced such that a highly transparent glass substrate may be obtained.

The processing temperature of the etching process is not particularly limited. However, the etching process is usually performed at a temperature within the range from 400° C. to 800° C. The temperature of the etching process is more preferably within the range from 500° C. to 700° C., and more preferably within the range from 550° C. to 650° C.

Note that the processing gas may also contain gases other than hydrogen fluoride gas, such as a carrier gas and/or a dilution gas. Examples of the carrier gas and the dilution gas include, but are not limited to, nitrogen and/or argon. Also, water may be added to the processing gas, for example.

The concentration of hydrogen fluoride gas in the processing gas is not particularly limited as long as the surface of the glass substrate may be etched as desired. For example, the concentration of the hydrogen fluoride gas in the processing gas may be within the range from 0.1 vol % to 10 vol %, more preferably within the range from 0.3 vol % to 5 vol %, and more preferably within the range from 0.5 vol % to 4 vol %. Note that the concentration (vol %) of the hydrogen fluoride gas in the processing gas may be obtained by the following formula.

Hydrogen Fluoride Gas Concentration (vol %)=Fluorine Gas Flow Rate/(Fluorine Gas Flow Rate+Carrier Gas Flow Rate+Dilution Gas Flow Rate)

The etching process may be performed on the glass substrate in a reaction chamber, for example. However, if necessary or desired, such as when a large glass substrate is being processed, for example, the etching process may be performed on the glass substrate while the glass substrate is being conveyed. In this case, the etching process may be performed faster and more efficiently as compared with the case of performing the etching process in a reaction chamber.

As described in detail below, in the first manufacturing method according to an embodiment of the present invention, the etching process is preferably performed under processing conditions that would not cause excessive etching of the glass substrate. That is, when the glass substrate is etched excessively, the writing feeling of the resulting cover glass may be degraded.

Note that the etching extent of the glass substrate is substantially influenced by various conditions, such as the processing temperature, the concentration of hydrogen fluoride gas, and the processing time, for example. In the present description, the term “etching intensity” is used as a relative indication of a combination of such conditions.

For example, under processing conditions where at least one of the processing temperature, the concentration of hydrogen fluoride gas, and the processing time is set to a relatively small value, the “etching intensity” may be lower than that in a case where the above processing conditions are set to “standard” values. In this case, the etching extent of the glass substrate is smaller as compared with the case where the above processing conditions are set to “standard” values.

Also, for example, under processing conditions where at least one of the processing temperature, the concentration of hydrogen fluoride gas, and the processing time is set to a relatively large value, the “etching intensity” may be higher than that in a case where the above processing conditions are set to “standard” values. In this case, the etching extent of the glass substrate is greater as compared with the case where the above processing conditions are set to “standard” values.

In the first manufacturing method according to the present embodiment, the above “etching intensity” is preferably arranged to be relatively low.

(Apparatus Used in Etching Process)

In the following, an example of a processing apparatus that may be used in the etching process of step S110 is briefly described.

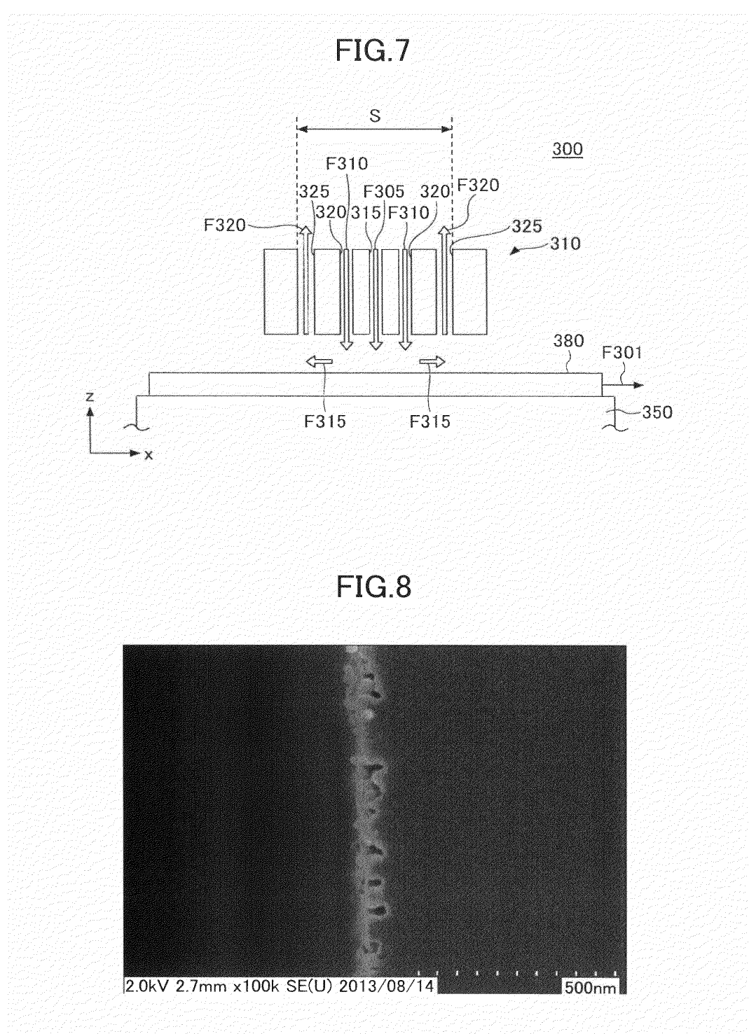

FIG. 7 shows an example configuration of a processing apparatus 300 used upon performing the etching process on the glass substrate. The processing apparatus 300 shown in FIG. 7 is capable of performing an etching process on a glass substrate while the glass substrate is being conveyed.

As shown in FIG. 7, the processing apparatus 300 includes an injector 310 and a conveying unit 350.

The conveying unit 350 is capable of conveying a glass substrate 380 that is placed thereon in a horizontal direction (X-axis direction) as represented by arrow F301 in FIG. 7.

The injector 310 is arranged above the conveying unit 350 and the glass substrate 380.

The injector 310 includes a plurality of slits 315, 320, and 325 acting as flow passages for the processing gas. That is, the injector 310 includes a first slit 315 extending in a vertical direction (Z-axis direction) at a central portion, a second slit 320 surrounding the first slit 315 and extending in the vertical direction (Z-axis direction), and a third slit 325 surrounding the second slit 320 and extending in the vertical direction (Z-axis direction).

One end (top end) of the first slit 315 is connected to a hydrogen fluoride gas source (not shown) and a carrier gas source (not shown), and the other end (bottom end) of the first slit 315 is oriented towards the glass substrate 380. Similarly, one end (top end) of the second slit 320 is connected to a dilution gas source (not shown), and the other end (bottom end) of the second slit 320 is oriented towards the glass substrate 380. Also, one end (top end) of the third slit 325 is connected to an exhaust system (not shown), and the other end (bottom end) of the third slit 325 is oriented towards the glass substrate 380.

In the case of performing an etching process on the glass substrate 380 using the processing apparatus 300 as described above, first, hydrogen fluoride gas is supplied in the direction of arrow F305 from the hydrogen fluoride gas source (not shown) through the first slit 315. Also, a dilution gas, such as nitrogen, is supplied in the direction of arrows F310 from the dilution gas source (not shown) through the second slit 320. Then, the exhaust system causes these gases to move in the horizontal direction (X-axis direction) along arrows F315 to then be discharged outside the processing apparatus 300 via the third slits 325.

Note that in some embodiments, a carrier gas, such as nitrogen, may be simultaneously supplied along with the hydrogen fluoride gas to the first slit 315.

Then, the conveying unit 350 is operated. As a result, the glass substrate 380 is moved in the direction of the arrow F301.

The glass substrate 380 comes into contact with the processing gas (hydrogen fluoride gas, carrier gas, and dilution gas) supplied from the first slit 315 and the second slit 320 when it passes the lower side of the injector 310. In this way, the surface of the glass substrate 380 may be etched.

Note that the processing gas supplied to the surface of the glass substrate 380 is used in the etching process while being moved in the direction of arrows F315 and is then moved in the direction of arrows F320 to be discharged outside the processing apparatus 300 via the third slit 325, which is connected to the exhaust system (not shown).

By using such a processing apparatus 300, an etching process may be performed on the surface of the glass substrate 380 with the processing gas while conveying the glass substrate 380. In this way, processing efficiency may be improved as compared with the case of performing the etching process in a reaction chamber. Also, by using such a processing apparatus 300, an etching process may be performed on a large glass substrate.

Note that the supply rate of the processing gas supplied to the glass substrate 380 is not particularly limited. For example, the supply rate of the processing gas may be in the range from 5 SLM to 1000 SLM. Note that “SLM” stands for “Standard Litter per Minute” (flow rate under standard conditions). Also, the time required for the glass substrate 380 to move past the injector 310 (time required to travel a distance S in FIG. 7) is preferably within the range from 1 second to 120 seconds, more preferably within the range from 2 seconds to 60 seconds, and more preferably within the range from 3 seconds to 30 seconds. By adjusting the time required for the glass substrate 380 to move past the injector 310 to be less than or equal to 120 seconds, the etching process may be performed promptly and efficiently.

As can be appreciated, by using the processing apparatus 300 as described above, an etching process may be performed on a glass substrate while the glass substrate is being conveyed.

Note that the processing apparatus 300 shown in FIG. 7 is merely one example, and the etching process on the glass substrate using the processing gas containing hydrogen fluoride gas may be performed using various other processing apparatuses. For example, in the processing apparatus 300 of FIG. 7, the glass substrate 380 is moving relative to the injector 310, which is stationary. However, in other processing apparatuses, the glass substrate may be stationary and the injector may be moved horizontally relative to the glass substrate, for example. Alternatively, both the glass substrate and the injector may be moved in opposite directions with respect to each other, for example.

Also, the injector 310 of the processing apparatus 300 of FIG. 7 includes a total of three slits 315, 320, and 325. However, the number of slits formed in the injector is not particularly limited. For example, the injector may include two slits. In this case, one of the slits may be utilized for supplying the processing gas (e.g. gas mixture of the carrier gas, the hydrogen fluoride gas, and the dilution gas), and the other slit may be utilized for discharging the processing gas. Also, one or more extra slits may be provided between the second slit 320 and the third slit 325, which is connected to the exhaust system, and an etching gas, a carrier gas, and/or a dilution gas may be supplied via the extra slits.

Further, in the processing apparatus 300 of FIG. 7, the second slit 320 of the injector 310 surrounds the first slit 315, and the third slit 325 surrounds the first slit 315 and the second slit 320. However, in an alternative arrangement, the first slit, the second slit, and the third slit may be arranged in rows along the horizontal direction (X-axis direction). In this case, the processing gas may move in one direction on the surface of the glass substrate and then be discharged through the third slit.

Further, a plurality of injectors 310 may be arranged above the conveying unit 350 along the horizontal direction (X-axis direction), for example.

Further, in some embodiments, another apparatus may be used to laminate a layer containing silicon oxide as a primary component on the surface of the glass substrate that has undergone the etching process, for example. By laminating such a layer, the chemical durability of the surface the glass substrate that has under gone the etching process may be improved, for example.

By performing the above-described process steps, at least one surface of the glass substrate may be etched.

Also, in some embodiments, the surface of the glass substrate may be masked before performing the etching process on the surface of the glass substrate. In this way, a desired region of the glass substrate surface may be selectively etched, or different etching conditions may be applied to different regions of the glass substrate, for example.

(Step S120)

Then, if necessary or desired, a chemical strengthening process may be performed on the glass substrate that has undergone the etching process as described above.

Note that “chemical strengthening process (method)” is a generic term for techniques that include immersing a glass substrate in molten salt containing an alkali metal, and replacing alkali metal (ions) having a small atomic diameter existing at a top surface of the glass substrate with alkali metal (ions) having a large atomic diameter existing within the molten salt. In a “chemical strengthening process (method)”, a surface of a glass substrate is processed to have alkali metal (ions) with an atomic diameter that is larger than the atomic diameter of alkali metal (ions) that were originally existing on the surface before the process. In this way, a compressive stress layer may be formed on the surface of the glass substrate, thereby improving the strength of the glass substrate.

For example, in a case where the glass substrate contains sodium (Na), the sodium may be replaced by potassium (K) in the molten salt (e.g., nitrate) during the chemical strengthening process. Alternatively, for example, in a case where the glass substrate contains lithium (Li), the lithium may be replaced by sodium (Na) and/or potassium (K) in the molten salt (e.g., nitrate) during the chemical strengthening process.

The processing conditions for the chemical strengthening process to be performed on the glass substrate are not particularly limited.

Examples of the types of molten salt that may be used include alkali metal nitrates, alkali metal sulfates, and alkali metal chloride salts, such as sodium nitrate, potassium nitrate, sodium sulfate, potassium sulfate, sodium chloride, potassium chloride, and the like. These molten salts can be used alone or may be used in combination.

The processing temperature (temperature of molten salt) may vary depending on the kind of the molten salt used. For example, the processing temperature may be within the range from 350° C. to 550° C.

For example, the chemical strengthening process may be performed by immersing the glass substrate for a period of 2 minutes to 20 hours in molten potassium nitrate salt at a temperature of 350° C. to 550° C. From an economic and practical standpoint, the chemical strengthening process is preferably performed at a temperature of 350° C. to 500° C. for a period 1 to 10 hours.

In this way, a glass substrate having a compressive stress layer formed on its surface may be obtained.

As described above, the process of step S120 is not an essential process step. However, by performing the chemical strengthening process on the glass substrate, the bending strength of the glass substrate may be improved. In this way, shatter resistance of the cover glass against contact with the input pen may be improved. Also, the strength of the entire cover glass may be improved.

(Step S130)

Then, if necessary or desired, an anti-finger print (AFP) coating process is performed on the surface of the glass substrate that has undergone the etching process. The coating process is referred to as “AFP coating process” hereinafter.

The AFP coating process may be performed in order to prevent stains such as fingerprints and grease from adhering on the surface of the cover glass, or to facilitate the removal of such stains.

The AFP coating process may be implemented by processing the surface of the glass substrate with a fluorine-based silane coupling agent containing fluorine and a functional group attached to the glass substrate, for example.

Note that an anti-fingerprint material used in the AFP coating process may be formed by exchanging the hydrogen found in glass terminal OH groups of the glass substrate with a fluorine-based moiety. For example, such an exchange may be carried out by the following reaction:

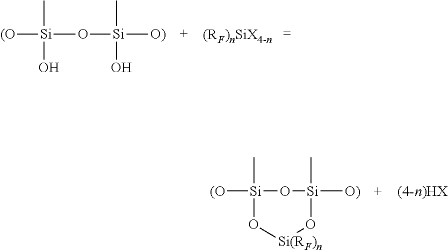

Note that in the above chemical reaction equation, R_{F} represents a C₁-C₂₂ alkyl perfluorocarbon or a C₁-C₂₂ alkyl perfluoropolyether, preferably a C₁-C₁₀ alkyl perfluorocarbon, and more preferably a C₁-C₁₀ alkyl perfluoropolyether; n represents an integer within the range from 1 to 3; and X represents a hydrolyzable group that can be exchanged with the glass terminal OH groups.

X is preferably a halogen other than fluorine or an alkoxy group (—OR). R may be a linear or branched hydrocarbon having 1-6 carbon atoms. For example, without limitation, R may be a —CH₃—C₂H₅—CH(CH₃)₂ hydrocarbon. In some embodiments n=2 or 3. The preferred halogen is chlorine. A preferred alkoxysilane is a trimethoxy silane, RFSi(OMe)₃. Additional perfluorocarbon moieties that can be used include (R_{F})₃SiCl, RF—C(O)—Cl, RF—C(O)—NH₂, and other perfluorocarbon moieties having a terminal group exchangeable with a glass hydroxyl (OH) group.

In the present description, the terms “perfluorocarbon”, “fluorocarbon” and “perfluoropolyether” refer to compounds having hydrocarbon groups as described herein in which substantially all of the C—H bonds have been converted into C—F bonds.

These compounds may be used alone, or may be used in combination. Also, a partially hydrolyzed condensate may be prepared in advance using an acid or alkali and this may be used in the AFP coating process.

The AFP coating process may be implemented by a dry method or a wet method, for example.

In the case where a dry method is used, a fluorine-based silane coupling agent may be deposited on the glass substrate by performing a film formation process such as vapor deposition, for example. Also, prior to such a process, an underlayer process may be performed on the glass substrate as is necessary or desired. Also, a heating process or a humidification process may be performed on the glass substrate to improve adhesion of the coating material, for example.

On the other hand, in the case where a wet method is used to perform the AFP coating process, a solution containing a fluorine-based silane coupling agent may be applied to the surface of the glass substrate, and the glass substrate may be dried thereafter. Prior to such a process, an underlayer process may be performed on the glass substrate if necessary or desired. Also, a heating process or a humidification process may be performed on the glass substrate to improve adhesion of the coating material, for example.

By performing the AFP coating process, the surface of the cover glass may be modified and wetting properties of the cover glass may be changed. For example, by performing the AFP coating process, a contact angle of the surface of the glass substrate with respect to a water droplet may be arranged to exceed 100 degrees.

As described above, the process of step S130 is not an essential process step.

However, by performing the AFP coating process on the glass substrate, stains such as fingerprints may be prevented from adhering to the surface of the cover glass, and removal of such stains may be facilitated. Note that in some embodiments, a masking process may be performed on the glass substrate before the AFP coating process, and in this way, the AFP coating process may be selectively performed on a desired region of the glass substrate surface. In this way, predetermined positions of the cover glass may be distinguished by recognizing the differences in the writing feeling at these positions.

Also, by performing the process of step S130, it may be easier to produce a surface having the above-mentioned features, namely, a surface characterized in that when a synthetic leather receiving a load of 50 gf (0.49 N) is moved in one direction, at a velocity of 1 mm/sec, at room temperature, on the surface of the cover glass 110, the coefficient of kinetic friction μₖ within a region where the relationship between the kinetic frictional force Fₖ (N) and the time is approximated by a straight line is greater than or equal to 0.9, and assuming σ (N) represents the standard deviation of the kinetic frictional force Fₖ (N) within the above region and Y represents σ/Fₖ, the value of Y is less than or equal to 0.05.

By performing the above process steps, the first cover glass according to an embodiment of the present invention having the features as described above may be manufactured.

Note that the manufacturing method described above is merely one example, and the first cover glass according to an embodiment of the present invention may be manufactured using other methods as well.

(Method for Manufacturing Second Cover Glass)

The second cover glass according to an embodiment of the present invention may be manufactured in a manner similar to the above-described method for manufacturing the first cover glass.

Note that example configurations and example methods for manufacturing a cover glass for a pen input device according to the present invention have been described above. However, a cover glass for a pen input device according to the present invention is not necessarily limited to the above examples. For example, input operations on the pen input device do not necessarily have to be performed using an input pen. Specifically, there are input devices that enable input operations through the touch of a finger in addition to input operations using an input pen.

A cover glass according to an embodiment of the present invention can also be applied as a cover glass for an input device that enables input operations using a finger. For example, as with the case of using an input pen, a jerky sensation may be suppressed and the writing feeling may be substantially improved when a finger is used to perform input operations with respect to an input device that uses a cover glass according to an embodiment of the present invention having a haze value of less than 1%, a Martens hardness within the range from 2000 N/mm² to 4000 N/mm², and a surface having the following features. That is, when a synthetic leather receiving a load of 50 gf (0.49 N) is moved in one direction, at a velocity of 1 mm/sec, at room temperature, on the surface of the cover glass, assuming Fₖ (N) represents the kinetic frictional force between the synthetic leather and the surface of the cover glass, σ (N) represents the standard deviation of the kinetic frictional force Fₖ (N), and Y represents σ/Fₖ, the coefficient of kinetic friction μₖ in a region where the relationship between the kinetic frictional force Fₖ (N) and the time is approximated by a straight line is greater than or equal to 0.9, and the value of Y, is less than or equal to 0.05.

### EXAMPLES

In the following, specific application examples are described.

### Example 1-1

A cover glass was manufactured by performing an etching process on a glass substrate as described below. Further, properties of the resulting cover glass were evaluated.

(Etching Process)

First, an aluminosilicate glass substrate manufactured by a float process and having a thickness of 1.1 mm was prepared.

Then, an etching process using HF gas was performed on this glass substrate. Note that the etching process was performed using the above-described processing apparatus 300 shown in FIG. 7.

In the processing apparatus 300, hydrogen fluoride (HF) gas and nitrogen gas were supplied to the first slit 315, nitrogen gas was supplied to the second slit 320, and the concentration of HF gas was adjusted to be 1.4 vol %.

The amount of exhaust from the third slit 325 was adjusted to be 2 times the total amount of gas supplied.

A first surface of the glass substrate (surface subject to the etching process) was arranged to face upward (as a processing surface facing toward the injector 310), and the glass substrate was heated to 580° C. and conveyed in such a state. Note that the temperature of the glass substrate was measured by conveying the same type of glass substrate having a thermocouple arranged thereon and measuring the temperature of the glass substrate under the same heating conditions. However, the surface temperature of the glass substrate may also be measured using a direct radiation thermometer, for example.

The etching process time (i.e., time required for the glass substrate to travel the distance S in FIG. 7) was set to about 5 seconds.

The first surface of the glass substrate was etched by performing the etching process under the above-described processing conditions. Hereinafter, the resulting glass substrate is referred to as “cover glass according to Example 1-1”.

### Example 2-1, Example 3-1, & Example 4-1

Cover glasses according to Example 2-1, Example 3-1, and Example 4-1 were manufactured under similar processing conditions as those used for manufacturing the cover glass according to Example 1-1. However, in these examples, the concentration of HF gas during the etching process was varied from that of the etching process performed to manufacture the cover glass according to Example 1-1.

Specifically, in Example 2-1, the concentration of HF gas was adjusted to be 1.9 vol %. In Example 3-1, the concentration of HF gas was adjusted to be 2.4 vol %. Further, in Example 4-1, the concentration of HF gas was adjusted to be 2.9 vol %.

Note that other processing conditions were the same as those used in Example 1-1.

(Evaluation)

The following properties of the cover glasses according to Examples 1-1, 2-1, 3-1, and 4-1 were measured.

(Haze Value)

The haze value was measured according to JIS K7361-1 using a haze meter (HZ-2 manufactured by Suga Test Instruments Co., Ltd.). A C light source was used as the light source.

(Martens Hardness)

The Martens hardness was measured according to ISO 14577 using a hardness tester (Picodenter HM500 manufactured by Fischer Instruments K.K.). Note that a Vickers indenter was used as the indenter.

(Surface Roughness)

The surface roughness Ra and the surface roughness Rz were measured according to JIS B0601 (2001) using a scanning probe microscope (SPI3800N manufactured by SII Nano Technology Inc.). The measurements were conducted with respect to a 2-μm square area of the cover glass at a data acquisition mode of 1024×1024 pixels.

Table 1 below collectively shows the etching process conditions and the measurements obtained with respect to the cover glasses according to the Examples 1-1 through 4-1.

TABLE 1

| | UNPROCESSED | | | | |
|---|---|---|---|---|---|
| | GLASS | | | | |
| EXAMPLE | SUBSTRATE | 1-1 | 2-1 | 3-1 | 4-1 |
| ETCHING | — | 580 | 580 | 580 | 580 |
| TEMPERATURE (° C.) | | | | | |
| HF CONCENTRATION | — | 1.4 | 1.9 | 2.4 | 2.9 |
| (vol %) | | | | | |
| ETCHING TIME (sec) | — | 5 | 5 | 5 | 5 |
| HAZE VALUE | 0.3 | 0.08 | 1.14 | 2.13 | 1.95 |
| MARTENS HARDNESS | 3700 | 2850 | 1060 | 530 | 740 |
| (N/mm²) | | | | | |
| Ra (nm) | 0.2 | 4.2 | 30 | 40 | 57 |
| Rz (nm) | 2.7 | 85 | 220 | 310 | 340 |

In the above Table 1, for reference, measurements obtained with respect to an “unprocessed glass substrate” that has not undergone the etching process are also shown.

As can be appreciated from the measurements of the haze value shown in Table 1, the haze value of the cover glass according to Example 1-1 is less than 1%, whereas the haze values of the cover glasses according to Example 2-1, Example 3-1 and Example 4 exceed 1%. Also, it can be appreciated from these measurements that as the HF concentration in the etching process, i.e., the “etching intensity”, increases, the haze value of the cover glass increases and the transparency of the cover glass decreases.

These measurements suggest that, under the above experimental conditions, in order to obtain a cover glass with a haze value of less than or equal to 1.0%, the HF concentration has to be less than 1.9 vol %.

Meanwhile, it can be appreciated from the measurements of the Martens hardness shown in Table 1 that the Martens hardness of the cover glass according to Example 1-1 is 2850 N/mm², whereas the Martens hardness of the cover glasses according to Example 2-1, Example 3-1, and Example 4-1 are substantially lower at no more than 1060 N/mm². Also, it can be appreciated from these measurements that as the HF concentration in the etching process, i.e., the “etching intensity” increases, the Martens hardness decreases and the hardness of the cover glass decreases.

These measurements suggest that, under the above experimental conditions, in order to obtain a cover glass having a Martens hardness within the range from 2000 N/mm² to 4000 N/mm², the HF concentration has to be less than 1.9 vol %.

Further, it can be appreciated from the measurements of the surface roughness shown in Table 1 that for the cover glass according to Example 1-1, the surface roughness Ra is within the range from 0.2 nm to 20 nm, and the surface roughness Rz is within the range from 3.5 nm to 200 nm. In contrast, for the cover glasses according to Example 2-1, Example 3-1, and Example 4-1, the surface roughness Ra is at least 30 nm, and the surface roughness Rz is at least 220 nm.

Also, it can be appreciated from these measurements that as the HF concentration in the etching process, i.e., the “etching intensity” increases, the surface roughness Ra and the surface roughness Rz tend to increase to thereby enhance the unevenness of the surface of the cover glass.

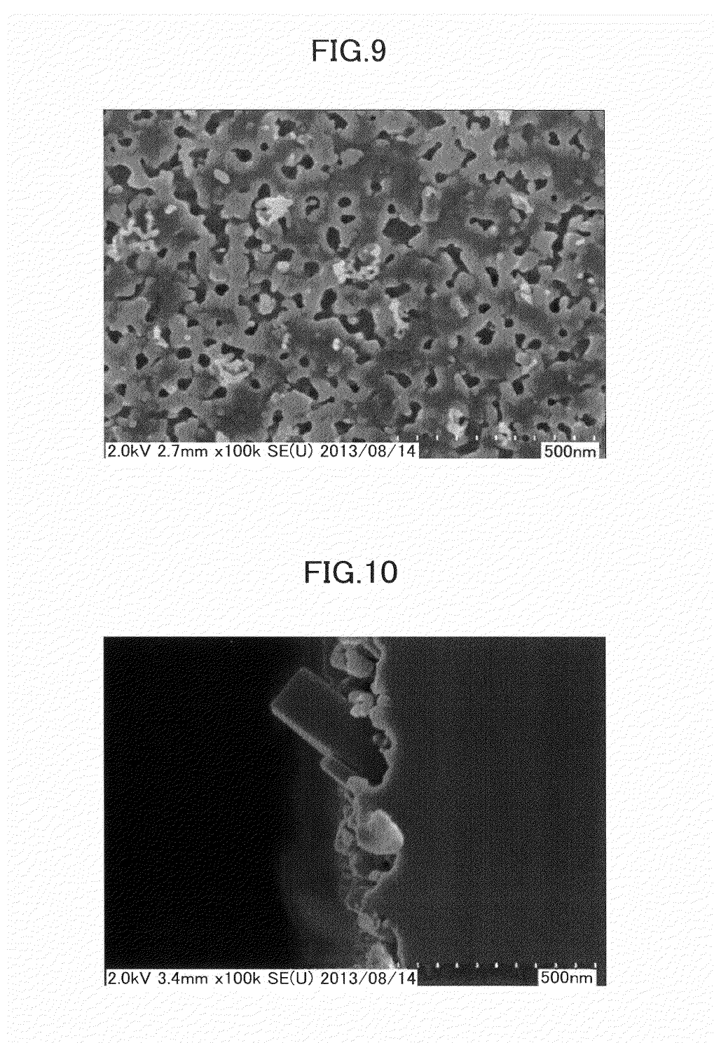

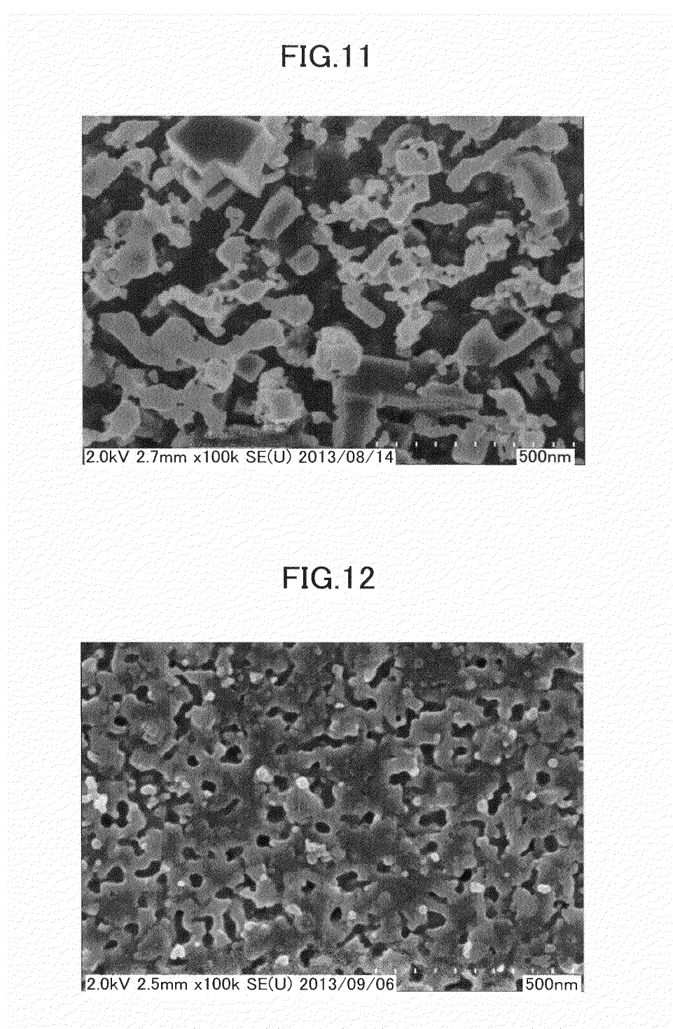

FIGS. 8 and 9 respectively show photographic images of a cross-section and the surface of the cover glass according to Example 1. FIGS. 10 and 11 respectively show photographic images of a cross-section and the surface of the cover glass according to Example 3-1.

It can be appreciated from these photographic images that the cover glass according to Example 3-1 has a rough and uneven surface including a large number of minute projections and holes distributed therein three-dimensionally. In contrast, the cover glass according to Example 1-1 has a relatively smooth and flat surface although it includes a large number of fine holes. Such a difference in the surface profiles may be attributed to the differences in the measured properties of the cover glasses according to Example 1-1 and the cover glasses according the Examples 2-1 through 4-1.

That is, because the etching intensity of the etching process for the cover glass according to Example 1-1 is relatively low, a relatively smooth surface may be obtained, and therefore, the surface roughness Ra and the surface roughness Rz may be relatively small. Also, for the same reason, a decrease in the Martens hardness of the cover glass according to Example 1-1 as compared with the glass substrate that has not undergone the etching process may be suppressed, and an increase in the haze value may be suppressed such that transparency of the cover glass may be enhanced.

### Example 5-1

A cover glass was manufactured by performing an etching process as described below on a glass substrate. Also, properties of the resulting cover glass were evaluated.

(Etching Process)

First, an aluminosilicate glass substrate manufacture by a float process and having a thickness of 0.7 mm was prepared.

Then, an etching process was performed on the glass substrate using HF gas. Note that the etching process was performed using the processing apparatus 300 as shown in FIG. 7.

Specifically, hydrogen fluoride (HF) gas and nitrogen gas were supplied to the first slit of the processing apparatus 300, nitrogen gas was supplied to the second slit 320, and the concentration of HF gas was adjusted to be 1.2 vol %.

The amount of exhaust from the third slit 325 was adjusted to be 2 times the total amount of gas supplied.

A first surface of the glass substrate, (surface subject to the etching process) was arranged to face upward (as a processing surface facing toward the injector 310), and the glass substrate was heated to 580° C. and conveyed in such a state. Note that the temperature of the glass substrate was measured by conveying the same type of glass substrate having a thermocouple arranged thereon and conveying the substrate under the same heating conditions. Note, however, that the surface temperature of the glass substrate may also be measured using a direct radiation thermometer, for example.

The etching process time (the time required for the glass substrate to travel the distance S in FIG. 7) was set to approximately 5 seconds.

The first surface of the glass substrate was etched by performing the etching process under the above-described processing conditions. Hereinafter, the resulting glass substrate is referred to as “cover glass according to Example 5-1”.

### Example 6-1

A cover glass according to Example 6-1 was manufactured by a method similar to the above-described method for manufacturing the cover glass according to Example 5-1. However, according to Example 6-1, the concentration of HF gas was adjusted to be 0.5 vol %. Other etching conditions were arranged to be the same as Example 5-1.

(Evaluation)

Using the evaluation methods as described above, the haze value, the Martens hardness, and the surface roughness of the cover glasses according to Example 5-1 and Example 6-1 were measured.

Table 2 below collectively shows the etching process conditions and the measurements obtained with respect to the cover glasses according to Example 5-1 and Example 6-1.

TABLE 2

| | UNPROCESSED | | |
|---|---|---|---|
| | GLASS | | |
| EXAMPLE | SUBSTRATE | 5-1 | 6-1 |
| ETCHING | — | 580 | 580 |
| TEMPERATURE (° C.) | | | |
| HF CONCENTRATION | — | 1.2 | 0.5 |
| (vol %) | | | |
| ETCHING TIME (sec) | — | 5 | 5 |
| HAZE VALUE | 0.35 | 0.08 | 0.07 |
| MARTENS HARDNESS | 3900 | 3380 | 3820 |
| (N/mm²) | | | |
| Ra (nm) | 0.3 | 1.2 | 0.2 |
| Rz (nm) | 3.4 | 15.8 | 3.9 |

In the above Table 2, for reference, measurements obtained with respect to an “unprocessed glass substrate” that has not undergone the etching process are also shown.

### Example 1-2

A cover glass was manufactured using a method as described below. Also, properties of the resulting cover glass were evaluated.

Specifically, the cover glass was manufactured by performing a chemical strengthening process after performing the etching process on the glass substrate obtained in Example 1-1. Hereinafter, the resulting cover glass is referred to as “cover glass according to Example 1-2”.

Note that the same processing conditions as those of Example 1-1 were used in the etching process performed in Example 1-2. Further, the chemical strengthening process in Example 1-2 was performed by immersing the glass substrate in 100% potassium nitrate molten salt at 450° C. for 2 hours.

By performing such a chemical strengthening process, a compression stress layer was formed on the surface of the glass substrate.

The surface compressive stress of the cover glass according to Example 1-2 was measured using a glass surface stress meter (FSM-6000LE manufactured by Orihara Manufacturing Co., Ltd.). As a result, the surface compressive stress of the first surface (surface subject to etching process) was about 835 MPa. Also, the surface compressive stress of a second surface (surface opposite the first surface) was similarly about 835 MPa.

Further, the same instrument was used to measure the thickness (depth) of the compressive stress layer formed on the surface of the cover glass that has undergone the chemical strengthening process. As a result, the thickness of the compressive stress layer formed on the first surface and the thickness of the compressive stress layer formed on the second surface were both about 36 μm.

### Example 2-2, Example 3-2, & Example 4-2

Cover glasses according to Example 2-2, Examples 3-2, and Example 4-2 were manufactured in a manner similar to the above-described method for manufacturing the cover glass according to Example 1-2. However, in these examples, the concentration of HF gas in the etching process was varied from the etching process of Example 1-2.

Specifically, in Example 2-2, the concentration of HF gas was adjusted to be 1.9 vol %. In Example 3-2, the concentration of HF gas was adjusted to be 2.4 vol %. Further, in Example 4-2, the concentration of HF gas was adjusted to be 2.9 vol %.

Note that other processing conditions were the same as those used in Example 1-2.

(Evaluation)

Using the evaluation methods as described above, the haze value, the Martens harness, the surface roughness Ra, and the surface roughness Rz of the cover glasses according to Examples 1-2, 2-2, 3-2, and 4-2 were measured.

Table 3 below collectively shows the etching conditions and the measurements obtained with respect to the cover glasses according to Examples 1-2, 2-2, 3-2, and 4-2.

TABLE 3

| | UNPROCESSED | | | | |
|---|---|---|---|---|---|
| | GLASS | | | | |
| EXAMPLE | SUBSTRATE* | 1-2 | 2-2 | 3-2 | 4-2 |
| ETCHING | — | 580 | 580 | 580 | 580 |
| TEMPERATURE (° C.) | | | | | |
| HF CONCENTRATION | — | 1.4 | 1.9 | 2.4 | 2.9 |
| (vol %) | | | | | |
| ETCHING TIME (sec) | — | 5 | 5 | 5 | 5 |
| HAZE VALUE | 0.35 | 0.05 | 0.65 | 2.15 | 2.48 |
| MARTENS | 3900 | 2950 | 1390 | 1030 | 570 |
| HARDNESS | | | | | |
| (N/mm²) | | | | | |
| Ra (nm) | 0.3 | 6.6 | 25 | 37 | 52 |
| Rz (nm) | 3.4 | 90 | 230 | 330 | 350 |

*GLASS SUBSTRATE AFTER CHEMICAL STRENGTHENING PROCESS

In Table 3, for reference, measurements obtained with respect to an “unprocessed glass substrate” (with a thickness of 1.1 mm) that has only been subjected to the chemical strengthening process but not the etching process are also shown.

It can be appreciated from the measurements of the haze value shown in Table 3 that the haze values of the cover glasses according to Example 1-2 and Example 2-2 are less than 1%, whereas the haze values of the cover glasses according to Example 3-2 and Example 4-2 exceed 2%. Also, it can be appreciated from these measurements that as the HF concentration in the etching process, i.e. “etching intensity” increases, the haze value of the cover glass increases, and the transparency of the cover glass decreases.

These measurements suggest that, under the above experimental conditions, in order to obtain a cover glass having a haze value of less than or equal to 1%, the HF concentration in the etching process has to be less than 2.4 vol %.

Meanwhile, it can be appreciated from the measurements of the Martens hardness shown in Table 3 that the Martens hardness of the cover glass according to Example 1-2 is 2950 N/mm², whereas the Martens hardness of the cover glasses according to Example 2-2, Example 3-2, and Example 4-2 are substantially lower at no more than 1390 N/mm². Also, it can be appreciated from these measurements that as the HF concentration of the etching process, i.e., the “etching intensity” increases, the Martens hardness decreases and the hardness of the cover glass decreases.

These measurements suggest that, under the above experimental conditions, in order to obtain a cover glass having a Martens hardness within the range from 2000 N/mm² to 4000 N/mm², the HF concentration of the etching process has to be less than 1.9 vol %.

Further, it can be appreciated from the measurements of the surface roughness of the cover glasses shown in Table 3 that the cover glass according to Example 1-2 has a surface roughness Ra within the range from 0.2 nm to 20 nm and a surface roughness Rz within the range from 3.5 nm to 200 nm. In contrast, for the cover glasses according to Example 2-2, Example 3-2, and Example 4-2, the surface roughness Ra is at least 25 nm, and the surface roughness Rz is at least 230 nm.

It can be appreciated from these measurements that as the HF concentration in the etching process, i.e. the “etching intensity” increases, the surface roughness Ra and the surface roughness Rz tend to increase to thereby enhance the unevenness of the surface of the cover glass.

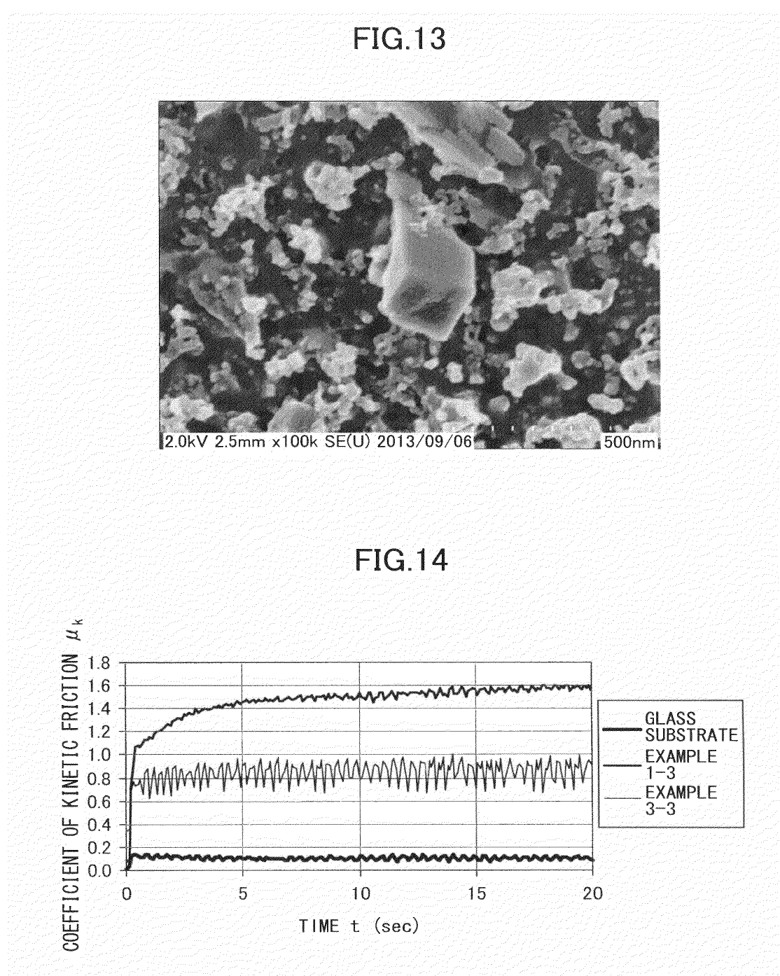

FIG. 12 shows a photographic image of the surface of the cover glass according to Example 1-2. FIG. 13 shows a photographic image of the surface of the cover glass according to Example 3-2.

It can be appreciated, based on a comparison of FIG. 12 and FIG. 9, and a comparison of FIG. 13 and FIG. 11, that no substantial change in the surface profile occurs as a result of performing the chemical strengthening process on the cover glass.

That is, the cover glass according to Example 3-2 has a highly uneven surface profile including a large number of minute projections and holes distributed three-dimensionally. In contrast, the cover glass according to Example 1-2 has a relatively smooth and flat surface profile although it includes a large number of fine holes.

As described above, because the “etching intensity” of the etching process for the cover glass according to Example 1-2 is relatively low, a relatively smooth surface may be obtained, and the surface roughness Ra and the surface roughness Rz may be relatively small. For the same reason, a decrease in the Martens hardness as compared with the glass substrate that has not undergone the etching process may be suppressed, and an increase in the haze value may be suppressed such that the transparency of the cover glass may be enhanced.

### Example 1-3

A cover glass was manufactured by a method as described below. Also, properties of the resulting cover glass were evaluated.

Specifically, the cover glass was manufactured by performing an AFP coating process on the surface of the cover glass obtained in Example 1-2. Hereinafter, the resulting cover glass is referred to as “cover glass according to Example 1-3”.

The AFP coating process was performed using a vapor deposition method to form a film made of KY185 (manufactured by Shin-Etsu Chemical Co., Ltd.) on the first surface of the cover glass obtained in Example 1-2.

### Example 2-3, Example 3-3, & Example 4-3

Cover glasses according to Example 2-3, Example 3-3, and Example 4-3 were manufactured using methods similar to the above-described method for manufacturing the cover glass according to Example 1-3. However, in these examples, the AFP coating process was performed on chemically strengthened glass substrates that were different from the chemically strengthened glass substrate that was subject to the AFP coating process in Example 1-3.

Specifically, in Example 2-3, the AFP coating process was performed on the first surface of the cover glass obtained in Example 2-2 to manufacture the cover glass according to Example 2-3. In Example 3-3, the AFP coating process was performed on the first surface of the cover glass obtained in Example 3-2 to manufacture the cover glass according to Example 3-3. Further, in Example 4-3, the AFP coating process was performed on the first surface of the cover glass obtained in Example 4-2 to manufacture the cover glass according to Example 4-3.

Note that other processing conditions of the AFP coating process performed in these examples were the same as those of Example 1-3.

### Example 5-3

A cover glass was manufactured by performing a chemical strengthening process and an AFP coating process as described below on the above-described cover glass according to Example 5-1. Hereinafter, the resulting cover glass is referred to as “cover glass according to Example 5-3”.

The chemical strengthening process was performed by immersing the cover glass according to Example 5-1 in 100% potassium nitrate molten salt at 450° C. for one hour. By performing such a chemical strengthening process, a compressive stress layer was formed on the surface of the cover glass.

After performing the chemical strengthening process, the surface compressive stress of the first surface (surface subject to the etching process) and the thickness of the compressive stress layer were measured using the evaluation methods as described above. As a result, the surface compressive stress of the first surface was about 760 MPa, and the thickness of the compressive stress layer was about 25 μm.

Then, an AFP coating process was performed on the cover glass that has undergone the chemical strengthening process.

Note that the processing conditions of the AFP coating process performed in Example 5-3 were the same as those of the AFP coating process performed in Example 1-3.

(Evaluation)

Using the evaluation methods as described above, the haze value, the Martens hardness, the surface roughness Ra, and the surface roughness Rz of the cover glasses according to Example 1-3, Example 2-3, Example 3-3, Example 4-3, and Example 5-3 were measured.

Also, the cover glasses according to Example 1-3, Example 2-3, Example 3-3, Example 4-3, and Example 5-3 were subject to contact angle measurement, frictional behavior evaluation, and writing feeling evaluation as described below.

(Contact Angle Measurement)

The contact angle was measured by dropping 1 μl of pure water on the surface of the cover glass and measuring the contact angle of the surface of the cover glass with respect to the water droplet 3 seconds thereafter. A contact angle meter (CA-X manufactured by Kyowa Interface Science Co., Ltd.) was used to measure the contact angle.

(Frictional Behavior Evaluation)

The coefficient of kinetic friction μₖ and the value of Y (Y=σ/Fₖ) of each of the cover glasses according to the above examples were determined in the manner described below.

First, a flat indenter with a load cell was placed on the first surface of each cover glass at a load of 50 gf (0.49 N). Note that a synthetic leather (with a thickness of 0.6 mm and a surface roughness Ra of 15 μm) was placed on at least a region (with an area of 1 cm²) of the contact surface where the indenter came into contact with the cover glass.

Then, the indenter was moved at a constant velocity (1 mm/sec) in a horizontal direction. The moving distance was arranged to be 20 mm. Then, the kinetic frictional force Fₖ (N) exerted by the surface of the cover glass upon moving the indenter and the coefficient of kinetic friction μₖ were determined using a surface property tester (TRIBOGEAR TYPE 38 manufactured by Shinto Scientific Co., Ltd.).

Note that the coefficient of kinetic friction μₖ was calculated with respect to a region where an approximately linear relationship was established between the kinetic frictional force Fₖ (N) and the moving time t (sec), such a region being referred to as “linear region” hereinafter.

Also, the value of Y was obtained by dividing the standard deviation σ (N) of the kinetic frictional force Fₖ (N) within the linear region by the kinetic frictional force Fₖ (N).

Note that this experiment was performed at room temperature (25° C.).

(Writing Feeling Evaluation)

Evaluations (sensory evaluations) of the writing feeling of the cover glasses according to Example 1-3, Example 2-3, Example 3-3, Example 4-3, and Example 5-3 were conducted in the manner described below.

In the evaluation of the writing feeling, an input pen (Pro Pen KP-503E manufactured by Wacom Co., Ltd) was used to actually draw objects on the cover glass, and an evaluation of “◯” was given if the experience was close to the sensation of writing on plain paper with an HB pencil, whereas an evaluation of “X” was given if drawing on the cover glass felt uneasy or awkward.

Table 4 below collectively shows the etching process conditions, the measurements, and the evaluation results obtained with respect the cover glass according to the above examples.

TABLE 4

| | UNPROCESSED | EXAMPLE | | | | |
|---|---|---|---|---|---|---|
| | GLASS SUBSTRATE* | 1-3 | 2-3 | 3-3 | 4-3 | 5-3 |
| ETCHING TEMPERATURE | — | 580 | 580 | 580 | 580 | 580 |
| (° C.) | | | | | | |
| HF CONCENTRATION (vol %) | — | 1.4 | 1.9 | 2.4 | 2.9 | 0.5 |
| ETCHING TIME (sec) | — | 5 | 5 | 5 | 5 | 5 |
| HAZE VALUE | — | 0.04 | 1.14 | 1.92 | 2.37 | 0.15 |
| MARTENS | 4000 | 3300 | 900 | 730 | 920 | 3850 |
| HARDNESS (N/mm²) | | | | | | |
| Ra (nm) | 0.3 | 5.7 | 24 | 30 | 50 | 0.3 |
| Rz (nm) | 3.5 | 80 | 230 | 320 | 320 | 4.5 |
| CONTACT ANGLE (°) | 117 | 120 | 141 | 145 | 146 | 100 |
| COEFFICIENT OF | 0.105 | 1.49 | 0.853 | 0.869 | 0.807 | 1.523 |
| KINETIC FRICTION μₖ | | | | | | |
| Y (σ/Fₖ) | 0.115 | 0.018 | 0.065 | 0.112 | 0.101 | 0.01 |
| WRITING FEELING | X | ◯ | X | X | X | ◯ |
| EVALUATION RESULT | | | | | | |

*GLASS SUBSTRATE AFTER CHEMICAL STRENGTHENING PROCESS & AFP COATING PROCESS

In the above Table 4, for reference, measurements and evaluations obtained with respect to an “unprocessed glass substrate” (with a thickness of 1.1 mm) that has undergone the chemical strengthening process and the AFP coating process but not the etching process are also shown.

As can be appreciated from the measurements of the haze value shown in Table 4, the haze values of the cover glasses according to Example 1-3 and Example 5-3 are less than 1%, whereas the haze values of the cover glasses according to Example 2-3, Example 3-3, and Example 4-3 exceed 1%. Also, it can be appreciated from these measurements that as the HF concentration in the etching process, i.e. the “etching intensity” increases, the haze value of the cover glass increases and the transparency of the cover glass decreases.

These measurements suggest that, under the above experimental conditions, in order to obtain a cover glass having a haze value of less than or equal to 1%, the HF concentration in the etching process has to be less than 1.9 vol %.

Meanwhile, it can be appreciated from the measurements of the Martens hardness shown in Table 4 that the cover glass according to Example 1-3 has a Martens hardness of 3300 N/mm², and the cover glass according to Example 5-3 has a Martens hardness of 3850 N/mm². In contrast, the Martens hardness of the cover glasses according to Example 2-3, Example 3-3, and Example 4-3 are substantially lower at no more than 920 N/mm². It can be appreciated from these measurements that as the HF concentration in the etching process, i.e., the “etching intensity” increases, the Martens hardness decreases and the hardness of the cover glass decreases.

These measurements suggest that, under the above experimental conditions, in order to obtain a cover glass having a Martens hardness within the range from 2000 N/mm² to 4000 N/mm², the HF concentration in the etching process has to be less than 1.9 vol %.

Further, it can be appreciated from the measurements of the surface roughness shown in Table 4 that for the cover glasses according to Example 1-3 and Example 5-3, the surface roughness Ra is within the range from 0.2 nm to 20 nm, and the surface roughness Rz is within the range from 3.5 nm to 200 nm. In contrast, for the cover glasses according to Example 2-3, Example 3-3, and Example 4-3, the surface roughness Ra is at least 24 nm, and the surface roughness Rz is at least 230 nm.

It can be appreciated from these measurements that as the HF concentration in the etching process, i.e. the “etching intensity” increases, the surface roughness Ra and the surface roughness Rz tend to increase to thereby enhance the unevenness of the surface of the cover glass.

Note that microscopic observations of the surfaces of the cover glasses revealed that the surface of the cover glass according to Example 1-3 was substantially similar to those of the cover glasses according to Example 1-1 and Example 1-2. Also, the surface of the cover glass according to Example 3-3 was substantially similar to those of the cover glasses according to Example 3-1 and Example 3-2. Based on the above, it can be appreciated that no substantial change in the surface profile of the cover glass occurs by performing the AFP coating process on the cover glass.

Also, it can be appreciated from the measurements of the contact angle that all of the cover glasses have contact angles of at least 100 degrees.

Also, it can be appreciated from the evaluation results of the frictional behavior that for the cover glass according to Example 1-3, the coefficient of kinetic friction μₖ is 1.49, and for the cover glass according to Example 5-3, the coefficient of kinetic friction μₖ is 1.523. In contrast, for the cover glasses according to Example 2-3, Example 3-3, and Example 4-4, the coefficient of kinetic friction μₖ is substantially smaller at no more than 0.869 (Example 3-3). Note that the coefficient of kinetic friction μₖ of the “unprocessed glass substrate” that has undergone the AFP coating process but not the etching process was even smaller at 0.105.

Further, the value of Y for the cover glass according to Example 1-3 is 0.018, and the value of Y for the cover glass according to Example 5-3 is 0.010. In contrast, the values of Y for the cover glasses according to Example 2-3, Example 3-3, and Example 4-4 are at least 0.065 (Example 3-3). Note that the value of Y for the “unprocessed glass substrate” that has undergone the AFP coating process is even larger at 0.115.

These measurements and evaluation results suggest that, under the above experimental conditions, in order to obtain a cover glass with a coefficient of kinetic friction μₖ greater than or equal to 0.9 and a value of Y less than or equal to 0.05, the HF concentration in the etching process has to be less than 1.9 vol %.

FIG. 14 is a graph showing the combined evaluation results of the frictional behavior of the cover glasses according to Example 1-3 and Example 3-3. Also, note that in the graph of FIG. 14, for reference, evaluation results obtained with respect to the glass substrate (with a thickness of 1.1 mm) that has only undergone the chemical strengthening process and the AFP coating process but not the etching process are also shown.

As can be appreciated from the graph of FIG. 14, the relationship between the coefficient of kinetic friction μₖ and the time t obtained with respect to the cover glass according to Example 3-3 is similar to the relationship shown in FIG. 3 described above. Therefore, it may be predicted that the writing feeling of the input pen would be degraded when such a cover glass is used. In contrast, the relationship between the coefficient of kinetic friction μₖ and the time t obtained with respect to the cover glass according to Example 1-3 is similar to the relationship shown in FIG. 4 described above. Therefore, it may be predicted that a favorable writing feeling can be obtained when using such a cover glass.

Note that the writing feeling evaluation results revealed that a jerky sensation of the input pen was felt upon moving the input pen on the cover glasses according to Examples 2-3 through 4-3. Also, an unfavorable writing feeling was obtained with respect to the glass substrate that has only undergone the chemical strengthening process and the AFP coating process but not the etching process owing to the input pen sliding too easily. In contrast, neither a jerky sensation nor excessive sliding occurred upon moving the input pen on the cover glasses according to Example 1-3 and Example 5-3, and favorable writing evaluation results were obtained with respect to these cover glasses.

Further, similar sensory evaluations of frictional behavior were conducted with respect to the above cover glasses by performing input operations using a finger (hereinafter also referred to as “finger input operations”). The evaluation results revealed that a suitable frictional sensation could be obtained when performing finger input operations with respect to the cover glasses according to Examples 1-3 and Example 5-3 and favorable writing feeling evaluations could be obtained for these cover glasses. In contrast, excessive sliding of the finger occurred with respect to the glass substrate that has only undergone the chemical strengthening process and the AFP coating process, and a jerky (chattering) sensation was felt when finger input operations were performed on the cover glasses according to Examples 2-3 through 4-3.

### Example 5-4

A cover glass was manufactured by performing a chemical strengthening process and an AFP coating process on the cover glass according to the above Example 5-1 in the manner described below. Hereinafter, the resulting cover glass is referred to as “cover glass according to Example 5-4”.

The chemical strengthening process was performed by immersing the cover glass according to Example 5-1 in 100% potassium nitrate molten salt at 450° C. for one hour. By performing such a chemical strengthening process, a compressive stress layer was formed the surface of the cover glass.

After performing the chemical strengthening process on the cover glass, the surface compressive stress of the first surface (surface subject to etching process) and the thickness of the compressive stress layer were measured using the above-described evaluation methods. As a result, the surface compressive stress of the first surface was about 760 MPa, and the thickness of the compressive stress layer was about 25 μm.

Then, an AFP coating process was performed on the cover glass that has undergone the chemical strengthening process.

The AFP coating process was performed using a vapor deposition method to form a film made of optool DSX (manufactured by Daikin Co., Ltd.) on the first surface of the cover glass.

After performing the AFP coating process, the amount of AFP coating material that has been applied to the first surface (AFP coating amount W) was determined by analyzing the line intensity of fluorine (F-Kα) using a X-ray fluorescence spectrometer. That is, because the AFP coating material contains fluorine, the amount of AFP coating material applied may be determined by determining the amount of fluorine.

Note that ZSX Primus II (manufactured by Rigaku Corporation; target: Rh, voltage: 50 kV, current: 72 mA) was used as the X-ray fluorescence spectrometer.

Also, the following formula was used to determine the AFP coating amount W.

AFP Coating Amount W={(F-Kα Line Intensity of Cover Glass After AFP Coating Process)−(F-Kα Line Intensity of Cover Glass Before AFP Coating Process)}/{(F-Kα Line Intensity of Standard Sample)−(F-Kα Line Intensity of Cover Glass Before AFP Coating Process)}

Note, also, that aluminosilicate glass containing fluorine at 2 wt % was used as the standard sample.

The evaluation results revealed that the AFP coating amount W for the cover glass that has undergone the AFP coating process, i.e., the cover glass according to Example 5-4, was 0.8.

### Example 5-5, Example 5-6, & Example 5-7

Cover glasses according to Example 5-5, Example 5-6, and Example 5-7 were manufactured using methods similar to the above-described method for manufacturing the cover glass according to Example 5-4. However, in these examples, the AFP coating amount W applied to the cover glasses in the AFP coating process was varied from the AFP coating amount W applied in Example 5-4.

Specifically, for the cover glass according to Example 5-5, the AFP coating amount W was adjusted to be 1.3; for the cover glass according to Example 5-6, the AFP coating amount W was adjusted to be 0.6; and for the cover glass according to Example 5-7, the AFP coating amount W was adjusted to be 2.8. Note that other processing conditions used to manufacture the above cover glasses were the same as those used in Example 5-4.

### Example 6-4

A cover glass according to Example 6-4 was manufactured in a manner similar to the above-described method for manufacturing the cover glass according to Example 5-4. However, in Example 6-4, the chemical strengthening process and the AFP coating process was performed on the cover glass according to Example 6-1 as described above. Also, the AFP coating amount W to be applied in the AFP coating process was adjusted to be 0.2. Note that other processing conditions used to manufacture the cover glass according to Example 6-4 were the same as those used in Example 5-4.

(Evaluation)

Using the evaluation methods as described above, the haze value, the Martens hardness, the surface roughness Ra, the surface roughness Rz, and the contact angle of the cover glasses according to Examples 5-4, 5-5, 5-6, 5-7 and 6-4 were measured.

Also, the frictional behavior of an input pen when used on these cover glasses was evaluated in the manner descried below.

An input pen having a pen tip made of polyacetal resin (with a Rockwell hardness of M90) was used. The radius of curvature of the pen tip was about 700 μm.

To evaluate the frictional behavior, a flat indenter with a load cell was placed on the first surface of each cover glass at a load of 50 gf (0.49 N). In the present case, the input pen was vertically placed on a region (with an area of 1 cm²) of the first surface and used as the indenter that comes into contact with the cover glass.

Then, the indenter (i.e., input pen) was moved at a constant velocity (10 mm/sec) in a horizontal direction. The moving distance was arranged to be 20 mm. Then, the kinetic frictional force Fₖ (N) exerted by the first surface of the cover glass upon moving the indenter and the coefficient of kinetic friction μₖ were determined using a surface property tester (TRIBOGEAR TYPE 38 manufactured by Shinto Scientific Co., Ltd.).

Note that the coefficient of kinetic friction μₖ was calculated with respect to a region where an approximately linear relationship was established between the kinetic frictional force Fₖ (N) and the moving time t (sec), such a region being referred to as “linear region” hereinafter.

Also, the standard deviation σ (N) of the kinetic frictional force Fₖ (N) within the linear region was calculated.

Note that the evaluation was performed at room temperature (25° C.).

Also, sensory evaluations of the writing feeling of the cover glasses were conducted using the same input pen that was used in the frictional behavior evaluation.

Table 5 below collectively shows the measurements and evaluation results obtained with respect to the cover glasses according to Examples 5-4 through 5-7 and Example 6-4.

TABLE 5

| EXAMPLE | 5-4 | 5-5 | 5-6 | 5-7 | 6-4 |
|---|---|---|---|---|---|
| ETCHING | 580 | 580 | 580 | 580 | 580 |
| TEMPERATURE (° C.) | | | | | |
| HF CONCENTRATION | 1.2 | 1.2 | 1.2 | 1.2 | 0.5 |
| (vol %) | | | | | |
| ETCHING TIME (sec) | 5 | 5 | 5 | 5 | 5 |
| AFP COATING AMOUNT W | 0.8 | 1.3 | 0.6 | 2.8 | 0.2 |
| HAZE VALUE | 0.15 | 0.2 | 0.15 | 0.3 | 0.15 |
| MARTENS | 3400 | 3390 | 3400 | 3390 | 3850 |
| HARDNESS | | | | | |
| (N/mm²) | | | | | |
| Ra (nm) | 1.2 | 1.1 | 1.2 | 1.1 | 0.3 |
| Rz (nm) | 16 | 16 | 16 | 15 | 4.5 |
| CONTACT ANGLE (°) | 110 | 120 | 98 | 125 | 100 |
| COEFFICIENT OF KINETIC | 0.20 | 0.20 | 0.23 | 0.13 | 0.24 |
| FRICTION μₖ | | | | | |
| STANDARD DEVIATION σ OF | 0.01 | 0.02 | 0.04 | 0.01 | 0.01 |
| COEFFICIENT OF KINETIC | | | | | |
| FRICTION Fₖ | | | | | |
| WRITING FEELING | ∘ | ∘ | x | x | ∘ |
| EVALUATION RESULT | | | | | |

As shown in the above Table 5, the cover glasses according to the above examples all had haze values of less than 1%. Also, the Martens hardness of the cover glasses according to the above examples were all within the range from 2000 N/mm² to 4000 N/mm².

However, with respect to the sensory evaluation of the writing feeling of the cover glasses, when the input pen was operated on the cover glass according to Example 5-6, a substantial jerky (chattering) sensation was felt such that a favorable writing feeling evaluation could not be obtained for this cover glass. Also, for the cover glass according to Example 5-7, excessive sliding of the input pen occurred such that desired input operations could not be easily performed.

In contrast, for the cover glasses according to Examples 5-4, 5-5, and 6-4, jerky sensations of the input pen and excessive sliding of the input pen were not experienced, and favorable writing feeling evaluations could be obtained.

Also, referring to the measurements of the coefficient of kinetic friction μₖ and the standard deviation σ (N) of the kinetic frictional force Fₖ (N) shown in Table 5, the standard deviation σ (N) of the kinetic frictional force Fₖ (N) obtained with respect to the cover glass according to Example 5-6 was relatively large at 0.04, and the coefficient of kinetic friction μₖ obtained with respect to the cover glass according to Example 5-7 was relatively small at 0.13. In contrast, for each of the cover glasses according to Examples 5-4, 5-5, and 6-4, the coefficient of kinetic friction μₖ was within the range from 0.14 to 0.50, and the standard deviation σ (N) of the kinetic frictional force Fₖ (N) was less than or equal to 0.03.

The above findings suggest that the degradation in the writing feeling of the cover glasses according to Example 5-6 and Example 5-7 can be attributed to the frictional behavior, i.e., the standard deviation a of the kinetic frictional force Fₖ (N) and the coefficient of kinetic friction μₖ, of these cover glasses. That is, in the cover glasses according to Example 5-6 and Example 5-7, the coefficient of kinetic friction μₖ is relatively small, or the standard deviation σ of the kinetic frictional force Fₖ (N) is relatively large. In contrast, in the cover glasses according to Examples 5-4, 5-5, and 6-4, the coefficient of kinetic friction μₖ is within a predetermined range, and the standard deviation σ of the kinetic frictional force Fₖ (N) could be substantially reduced. The favorable writing feeling evaluations obtained with respect to these cover glasses may be attributed to such frictional behaviors of the cover glasses.

Although the present invention has been described above with respect to certain illustrative embodiments, the present invention is not limited to these embodiments, and various variations and modifications may be made without departing from the scope of the present invention.

What is claimed is:

1. A cover glass for a pen input device, the cover glass comprising a glass member having
a haze value of less than 1%; and
a Martens hardness within a range from 2000 N/mm² to 4000 N/mm²;
wherein when a moving member receiving a load of 150 gf (1.47 N) is moved in one direction, at a velocity of 10 mm/sec, at room temperature, on a surface of the cover glass, a coefficient of kinetic friction μₖ of a kinetic frictional force Fₖ (N) between the moving member and the surface of the cover glass within a region where a relationship between the kinetic frictional force Fₖ (N) and time is approximated by a straight line is greater than or equal to 0.14 and less than or equal to 0.50, and a standard deviation σ (N) of the kinetic frictional force Fₖ (N) is less than or equal to 0.03; and
wherein the moving member is a pen that includes a pen tip made of polyacetal resin having a Rockwell hardness of M90, and the pen tip has a radius of curvature of 700 μm.

2. The cover glass according to claim 1, wherein
the surface of the cover glass includes a plurality of regions; and
the coefficients of kinetic friction μₖ and the standard deviations σ (N) of the kinetic frictional force Fₖ (N) exerted by the plurality of regions differ from one another

3. A cover glass for a pen input device, the cover glass comprising a glass member having
a haze value of less than 1%; and
a Martens hardness within a range from 2000 N/mm² to 4000 N/mm²;
wherein when a moving member is moved in one direction on a surface of the cover glass, assuming Fₖ (N) represents a kinetic frictional force between the moving member and the surface of the cover glass, σ (N) represents a standard deviation of the kinetic frictional force Fₖ (N), and Y represents σ/Fₖ, Y is less than or equal to 0.05.

4. The cover glass according to claim 3, wherein
the surface of the cover glass includes a plurality of regions; and
the coefficients of kinetic friction μₖ and the standard deviations σ (N) of the kinetic frictional force Fₖ (N) exerted by the plurality of regions differ from one another.

5. The cover glass according to claim 3, wherein the Martens hardness of the cover glass is within a range from 2000 N/mm² to 3500 N/mm².

6. The cover glass according to claim 3, wherein
the moving member is a synthetic leather; and
when the moving member receiving a load of 50 gf (0.49 N) is moved in one direction, at a velocity of 1 mm/sec, at room temperature, on the surface of the cover glass, a coefficient of kinetic friction μₖ within a region where a relationship between the kinetic frictional force Fₖ (N) and time is approximated by a straight line is greater than or equal to 0.9.

7. The cover glass according to claim 3, wherein the surface of the cover glass has
a surface roughness Ra (arithmetic average roughness) within a range from 0.2 nm to 20 nm; and
a surface roughness Rz (maximum height roughness) within a range from 3.5 nm to 200 nm.

8. The cover glass according to claim 3, wherein an anti-fingerprint material is coated on the surface of the cover glass.

9. The cover glass according to claim 8, wherein the anti-fingerprint material is coated on at least a portion of the surface of the cover glass.

10. The cover glass according to claim 3, wherein a glass composition of the cover glass includes:
SiO₂ at 61-77 mol %;
Al₂O₃ at 1-18 mol %;
Na₂O at 8-18 mol %;
K₂O at 0-6 mol %;
MgO at 0-15 mol %;
B₂O₃ at 0-8 mol %;
CaO at 0-9 mol %;
SrO at 0-1 mol %;
BaO at 0-1 mol %; and
ZrO₂ at 0-4 mol %.

11. The cover glass according to claim 3, wherein a chemical strengthening process is performed on the cover glass.

12. The cover glass according to claim 3, wherein a contact angle of the surface of the cover glass with respect to a water droplet is greater than or equal to 100 degrees.

13. A cover glass for an input device used by a user to input information, the cover glass comprising a glass member having
a haze value of less than 1%; and
a Martens hardness within a range from 2000 N/mm² to 4000 N/mm²;
wherein when a synthetic leather receiving a load of 50 gf (0.49 N) is moved in one direction, at a velocity of 1 mm/sec, at room temperature, on a surface of the cover glass, assuming Fₖ (N) represents a kinetic frictional force between the synthetic leather and the surface of the cover glass, σ (N) represents a standard deviation of the kinetic frictional force Fₖ (N), and Y represents σ/Fₖ, a coefficient of kinetic friction μₖ within a region where a relationship between the kinetic frictional force Fₖ (N) and time is approximated by a straight line is greater than or equal to 0.9, and Y is less than or equal to 0.05.

14. The cover glass according to claim 13, wherein an input operation on the input device is performed by the user touching the cover glass with a finger.

15. The cover glass according to claim 13, wherein an input operation on the input device is performed by placing a pen in contact with the cover glass.
